(19) United States
(12) Patent Application Publication
(10) Pub. No.: US 2023/0241532 A1
(43) Pub. Date: Aug. 3, 2023

(54) NUTRIENT CONCENTRATION AND WATER RECOVERY SYSTEM AND ASSOCIATED METHODS

(71) Applicant: Renewable Energy Alternatives, LLC, Brush Prairie, WA (US)

(72) Inventor: Robert KNOOP, Brush Prairie, WA (US)

(73) Assignee: Renewable Energy Alternatives, LLC, Brush Prairie, WA (US)

(21) Appl. No.: 18/299,015

(22) Filed: Apr. 11, 2023

Related U.S. Application Data
(63) Continuation of application No. 16/357,512, filed on Mar. 19, 2019, now abandoned.
Application No. 16/357,512 is a continuation-in-part of application No. 14/952,305, filed on Nov. 25, 2015, now abandoned.
(60) Provisional application No. 62/084,325, filed on Nov. 25, 2014.

(51) Int. Cl. B01D 21/00; B01D 21/24; B01D 21/34; B01D 33/03; B01D 36/04; C02F 9/00; B01D 29/39; B01D 29/66; B01D 29/60; B01D 29/72

(52) U.S. Cl. CPC B01D 21/0012; B01D 21/2461; B01D 21/34; B01D 33/03; B01D 36/04; C02F 9/00; B01D 29/39; B01D 29/661; B01D 29/606; B01D 29/72; B01D 21/0018; B01D 2201/184; B01D 2311/2649; B01D 2311/2642; C02F 2001/007

(57) ABSTRACT

A nutrient concentration and water recovery system includes a first suspended solids settling tank configured to receive a flow stream that includes a waste stream with a sludge stream. A first centrifugal pump is coupled to the first suspended solids settling tank. The first centrifugal pump having corrosion resistant wetted parts and variable speed drives to transfer or pressurize process flow streams. A first level transmitter coupled to the first centrifugal pump that provides output signals in response to a level of a process material within the first suspended solids settling tank. The first level transmitter is mounted in the first suspended solids settling tank. A first flow transmitter coupled to the first level transmitter is configured to measure a specific volume of material transferred out of the first suspended solids settling tank. A first pump is coupled to the first flow meter and configured to transfer a flush water that includes suspended solids and inorganics. A vibrating screen is coupled to the first pump. A process tank is coupled to the submersible pump. A sedimentation removal system and a removal device coupled to the sedimentation removal system are provided and configured to remove inorganizes out of a suspension.

### CROSS-REFERENCE TO RELATED APPLICATION

The present application is a continuation of U.S. patent application Ser. No. 16/357,512, filed Mar. 19, 2019; which application is a continuation-in-part of U.S. patent application Ser. No. 14/952,305, filed Nov. 25, 2015; which application claims priority to U.S. Provisional Patent App. No. 62/084,325, filed Nov. 25, 2014, the contents of which are incorporated by reference as forth herein.

### FIELD OF THE INVENTION

The present invention is directed generally to nutrient concentration and water recovery systems and associated methods, and more particularly to removing all available nutrients and suspended organic matter thereby generating a much cleaner water component.

### BRIEF DESCRIPTION OF THE RELATED ART

The use of chemicals and/or replacement filters is both labor intensive and costly when compared to the Nutrient Concentration and Water Recovery system. In addition to avoiding the odorous off gassing from lagoons, the Nutrient Concentration and Water Recovery system generates distinctive low (volumetric) flow rejects streams. Each reject stream has specific total suspended solids (TSS) and total dissolved solids (TDS) characteristics.

When treating organic waste in order to feed an anaerobic digester, there is a need to maximize the waste material consistency in order to maximize the amount of volatile organic matter that can be processed in higher concentration digesters. As the processing time can involve many days, the capital cost of the digester equipment can be very high, unless the concentration of the organics can be increased. Unfortunately, the higher the concentration, the greater is the difficulty in pumping (transferring) the organic sludge between unit process steps. Consequently, normal high consistency feed levels as currently practiced are limited to 5 to 12% consistency.

Lagoons are used for aerobic digestion of organic material. In many cases, C AFO s or concentrated animal feed operations such as dairies, hog and swine operations or in other cases food processing plant waste streams utilize lagoons to process the organic material within their waste streams. This list of applications/industries is intended to be representative and not complete.

Lagoons are land intensive. They also have the potential during rainy seasons to spill over and contaminate local watersheds/water streams. In addition, the potential for noxious odors is very high. Although there is potential in the summer time to concentrate the nutrients by way of evaporation, aerobic lagoons also discharge nitrogen gas as well as methane to the atmosphere. The nitrogen would be better used to fertilize, while the methane gas is one of the more problematic greenhouse gas contributors. In fact, methane gas is 23 to 24 times more injurious to the atmosphere than carbon dioxide.

When the lagoon material is finally ready to be land applied, more than 100 to 250 days of storage within the lagoon has elapsed. The residual nutrients including potassium within the liquid fraction in the lagoon are applied in an “as is condition” which can in turn overload the fertilized fields with some nutrients. Levels as defined by the Nutrient Land Management Act are often exceeded. Phosphorous, given the slow release and pickup by the crops is usually the limiting nutrient.

All lagoon installations require ongoing maintenance.

### SUMMARY

An object of the present invention is to provide systems and methods that remove particulates from waste streams.

Another object of the present invention is to provide systems and methods that remove particulates from waste streams and reduce maintenance of lagoons.

Yet another object of the present invention is to provide systems and methods that remove particulates from waste streams to reduce maintenance of lagoons at selected locations.

A further object of the present invention is to provide systems and methods that remove particulates from waste streams and increase recovery of nutrients from waste streams.

Another object of the present invention is to provide systems and methods that remove particulates from waste streams and increase an amount of clean water for re-use.

Another object of the present invention is to provide systems and methods that remove particulates from waste streams and increase an amount of clean water for re-use that is low cost with reduced operator intervention.

Another object of the present invention is to reduce the particulate in the waste stream going to the lagoon(s) in the form of suspended solids (TSS) as organic matter and therefore reduce the aerobic action within the lagoon(s) thereby reducing the methane gas (biogas) released to the atmosphere because of the aerobic process.

Another object of the present invention is to reduce the loss of nitrogen within the waste stream which would naturally off gas if stored in an uncovered lagoon.

Another object of the present invention is to concentrate the nitrogen rich sludge and waste material removed from the waste stream and store in closed tanks in order to minimize nitrogen off gassing to the atmosphere.

Another object of the present invention is to provide a mobile Nutrient and Water Recovery system to perform the same objectives at seasonal lagoons, abandoned lagoons, or provide bypass capacity around existing systems to permit scheduled and unscheduled maintenance.

These and other objects of the present invention are achieved in a nutrient concentration and water recovery system. A first suspended solids settling tank is configured to receive a flow stream that includes a waste stream with a sludge stream. A first centrifugal pump is coupled to the first suspended solids settling tank. The first centrifugal pump having corrosion resistant wetted parts and variable speed drives to transfer or pressurize process flow streams. A first level transmitter coupled to the first centrifugal pump that provides output signals in response to a level of a process material within the first suspended solids settling tank. The first level transmitter is mounted in the first suspended solids settling tank. A first flow transmitter coupled to the first level transmitter is configured to measure a specific volume of material transferred out of the first suspended solids settling tank. A first pump is coupled to the first flow meter and configured to transfer a flush water that includes suspended solids and inorganics. A vibrating screen is coupled to the first pump. A process tank is coupled to the submersible pump. A sedimentation removal system and a removal device coupled to the sedimentation removal system are provided and configured to remove inorganizes out of a suspension.

### BRIEF DESCRIPTION OF DRAWINGS

FIG. 1 is a flow chart illustrating interconnections between sequential unit process systems 12, 14, 16 comprising system 10 in one embodiment of the present invention.

FIG. 2 element 28,60 illustrate a flow chart that illustrates use of a chemical metering process unit that can be utilized in one embodiment of the present invention for injecting chemicals into a primary flow stream.

FIG. 3 illustrates one embodiment of a unit process equipment that can be utilized with the present invention, more particularly to confirm the capability of certain automatic back washable filter units.

FIG. 4 element 26 illustrates one embodiment of a fractionation tank that includes a lamella clarifier in one embodiment of the present invention.

FIG. 5 element 58 illustrates a DAF unit process step used in one embodiment of the present invention.

FIG. 6 element 72 illustrates a plurality of reverse osmosis (RO) elements that can be utilized in one embodiment of the present invention.

FIG. 7 element 72 illustrates a two-stage reverse osmosis skid in one embodiment of the present invention.

FIG. 8 illustrates a flow diagram of a dairy field test carried in one embodiment of the present invention.

FIG. 9 illustrates one embodiment of a typical particle sized material that can be removed in one embodiment of the present invention.

FIG. 10 element 18 illustrates a vibrating screen that can be used in one embodiment of the present invention.

FIG. 11 element 68 illustrates a bag and cartridge filter assembly that can utilize in one embodiment of the present invention.

FIG. 12 illustrates element 50i1 lustrates a centrifugal separator that can be used in one embodiment of the present invention.

FIG. 13 illustrates element 32 a storage tank that can be used in one embodiment of the present invention.

FIG. 14 Overall Process Flow Diagram, Nutrient Concentration and Water Recovery.

### DETAILED DESCRIPTION

### Definitions

CAFO—Concentrated Animal Feed Operations.

NPK—primary plant nutrients, nitrogen (N), phosphorous (P), potassium (K).

Sludge—suspended solids extracted by mechanical filtration methods from an organic waste stream at a mechanical filtration stage/step.

Filtrate—the lower suspended solids, and more dilute waste stream leaving a mechanical filtration stage/step.

Lignin—woody based organic material with a make-up primarily of long stringy fiber which is very slowly broken down by aerobic or anaerobic digestion.

Bio-sludge-may contain primary plant nutrients and micro nutrients and organisms and solids which rebuild soil mechanics including but not limited to water retention, improved soil porosity. Can have suspended solids levels ranging from 2% to 30%.

Bio-stimulants—a watery filtrate containing much reduced primary plant nutrients and micro nutrients and organisms which rebuild soil mechanics including but not limited to water retention, improved soil porosity.

Bio-fertilizer—a general term referring tom materials that provide plant nutrients and may improve soil mechanicals of the agricultural soils. The nutrients are not sourced from chemically produced nutrients.

OMRI—Organic Materials Review Institute—OMRI supports organic integrity by developing clear information and guidance about materials, so that producers know which products are appropriate for organic operations.

BOD5— Biochemical Oxygen Demand over a 5-day duration—The biochemical oxygen demand (BOD5) test tries to closely model an aerobic wastewater treatment system and the natural aquatic ecosystem. It measures oxygen taken up by the bacteria during the oxidation of organic matter. The test usually runs for a five-day period, but can run 7 or 10 days as well, depending on specific sample circumstances.

ii-unit of measure equal to one/one millionth of a meter. Shown as the symbol id.

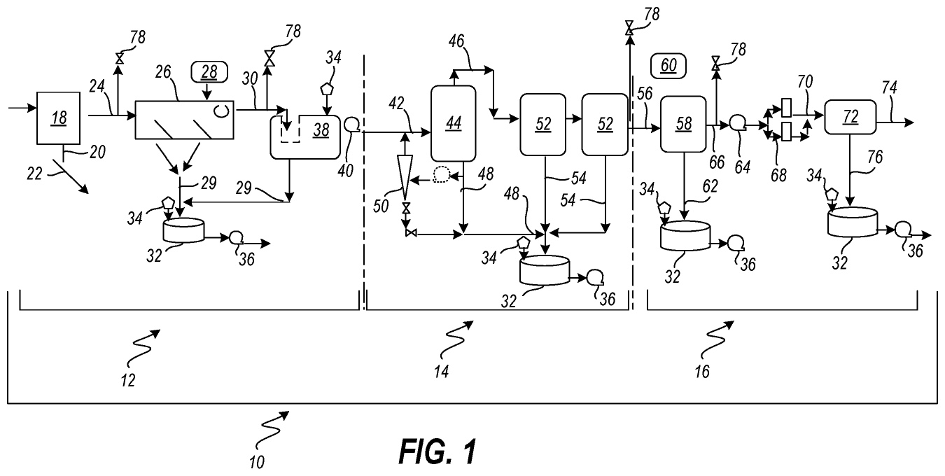

In one embodiment a nutrient concentration and water recovery system 10 (hereafter system 10) FIG. 1, and associated methods of its use are provided. As a non-limiting example, by removing the clean water component from the waste stream with this process technology, the original volatile organics in both the suspended solids and the dissolved solids state(s) can be retained and concentrated. In one embodiment the volatile organics level can be maximized. In one embodiment the present invention allows increasing the final targeted digester feed consistency (if required) without loss of the volatile organics.

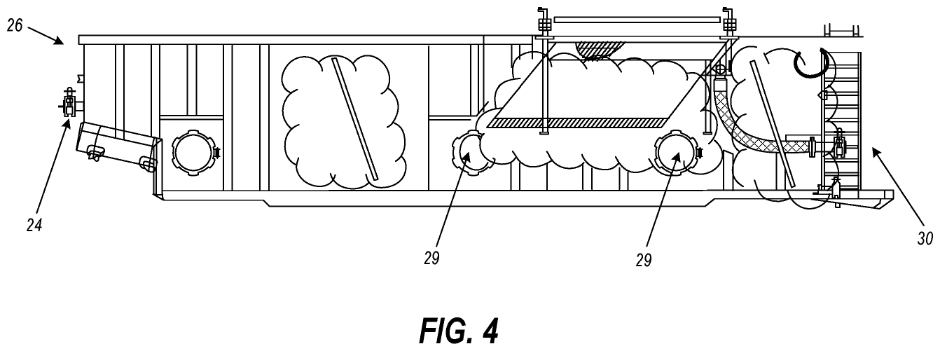

In one embodiment system 10, illustrated in FIG. 1 includes 3 stages and several unit processes within each stage. Stage 1 detailed as Subsystem 12 on FIG. 1 includes the initial wastewater dewatering equipment element 18 as well as a combination suspended solids settling tank and integral lamella clarifier element 26 FIG. 4. with discharge to either a surge tank or repurposed and designated lagoon element 38. Incorporated into this system Subsystem 12 FIG. 1 is a chemical metering skid element 28 in order to enhance the suspended solids removal performance of the lamella type clarifier and a sludge tank element 32 with appropriate controls element 34 and sludge handling system pump element 36. There is also located after surge tank element 38, a transfer pump element 40 which pressurizes the accumulated intermittent flow volume and transfers downstream to 2nd stage detailed as Subsystem 14 on FIG. 1.

This 1st stage of the overall nutrient concentration and water recovery system 10 is sized to handle peak flows as in the case of the intermittent barn flush activity. By non-limiting example, a 3000 head dairy if barn flushed 3 times per day can generate between 200,000 to 300,000 gallons of wastewater. Therefore, during the periods between barn flush activities, if the large and somewhat instantaneous flows can be contained, the downstream equipment can be downsized to take advantage of the overall time duration between barn flushes. There are large capital cost savings associated with reducing the size of the continuous downstream processing equipment. By non-limiting example, the situation above would result in continuous flow rates in the subsequent downstream stages 2 and 3, identified on FIG. 1 as Subsystem 14 and Subsystem 16 of 130 gallons per minute to 210 gallons per minute. In addition, the suspended solids removal equipment element 26 located after the vibrating screen or equivalent unit process element 18 is necessary to remove a substantial fraction of the suspended solids entering system 10. By removing between 40 to 90% of the TSS within incoming water at this point in the process maintenance associated with cleaning out either the surge tank element 38 or dedicated on-site lagoon is reduced. In addition, with a large portion of the settle able solids removed at this point in the process, the waste water quality would be improved allowing for greater recycling of this water for barn flush, more nutrient material extract to be used on site as a fertilizer substitute and reduced biogas (methane) off gassing at the waste water storage lagoon.

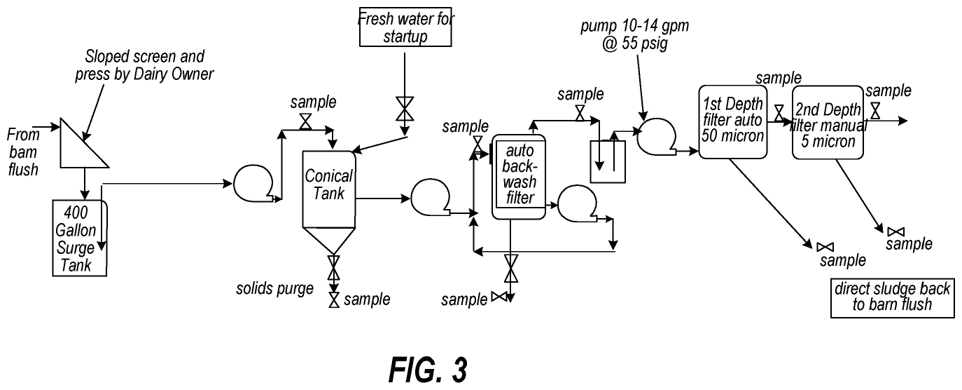

Detailed as Subsystem 14 on FIG. 1 represents the 2nd stage of the wastewater treatment system. Subsystem 14 includes a series of sequential automatic depth filters. Units can be equipped with progressively finer i.t. rated filters. Unit process element 44 FIG. 1 has an internal recirculating loop required to maintain filtration efficiencies. By cleaning the recirculated flow with centrifugal separator element 50 or equivalent, recirculated TSS material can be continually bled away from the system thereby reducing the amount of TSS material subject to fiber breakdown due to traveling through the recirculating pump. This ensures that suspended material is removed rather than reduced in size and therefore transferred downstream to be removed by finer i.t. rated depth filtration. As in the 1st stage, there is a common sludge removal system including a sludge tank element 32 with level controls element 34 and the sludge discharge pump element 36. FIG. 1 Subsystem 14 is sized for a much-reduced continuous flow when compared to Subsystem 12 which was discussed above. As final depth filtration which include unit's element 52 are rated down to 5 with actual particulate removal ranging from 5 to 2 lu., any residual TSS does not pose a settling problem in any of the on-site lagoon(s) or other storage tank. Reject streams elements 54 and 48 due to their similar characteristics are by non-limiting example co-mingled in the sludge tank element 32. Reference FIG. 3. In addition to the laboratory analysis, an industry standard jar type test was performed on the water quality exiting the pilot test equipment represented by FIG. 3. After an overnight settling period, there was no evidence of either suspended solids or settled solids in the jar test. Based on these results, the lab results and the absolute filtration rating of unit's element 52, very limited settling is anticipated in any of the lagoons on-site. This in turn minimizes lagoon maintenance, the potential for final lagoon liner damage associated with use of heavy sludge removal equipment, as well as minimal off gassing due to minimal TSS loading and minimal organic material.

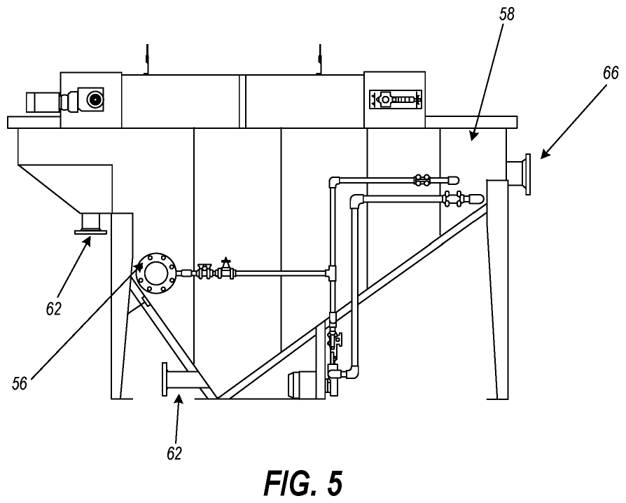

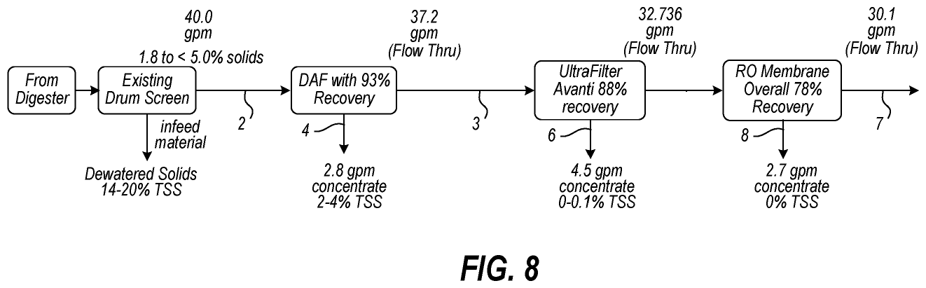

Subsystem 16 as shown in FIG. 1 is the final stage of filtration, nutrient removal and water recovery in system 10. The components within this Subsystem 16 incorporates many of the pilot test components used during the on dairy farm testing in 2012-2013, FIG. 8. Again, as in the case of Subsystem 14 FIG. 1, the hydraulic loading for this system based on a non-limiting case of a 3000 head dairy herd would be between 130 gallons a minute to 210 gallons a minute. Based upon minimal TSS loading after the 5 micron depth filter rated units, element 52, a dissolved aeration floatation (see FIG. 5) element 58 complete with flocculating chemical addition by chemical metering skid element 60, would reduce TSS loading in the accept stream element 66 such that the final in-line cartridge filters element 68 could remove any residual suspended solids. Sludge removed from the feed stream element 56 as shown in reject stream element 62 would be collected in sludge tank element 32 FIG. 1 with level in the tank controlled by level control element 34 which would activate sludge discharge pump element 36. The water quality as per flow stream element 70 FIG. 1, would be suitable as reverse osmosis (RO) feed water.

The optional reverse osmosis unit is included in system 10 if the final water quality leaving the system needs to be at a water quality level not restricted by EPA criteria. It is expected that this water subject to further testing will be equivalent to non-potable water. The incremental benefits of the reverse osmosis system are the removal of any elevated chlorides within flow stream element 70 as well as any elevated phosphorus levels. Note phosphorus used hereafter is intended to refer to the phosphorus compounds associated with its use as a key fertilizer element. Excess salts in irrigation water can lead to damaged croplands and phosphorous due to its very stable nature and slow pickup by crops is usually the nutrient that exceeds Nutrient Land Management Act levels. Because of the cost of reverse osmosis element 72 FIG. 1, a smaller reverse osmosis system not sized for the full process flow element 70 may be installed. This is possible because the chloride and phosphorous levels are so reduced going through the reverse osmosis that a blended strategy with water not treated by the reverse osmosis system can be utilized and therefore the capital cost of the overall nutrient concentration and water recovery system 10 can be reduced. On a weighted average basis, if the reverse osmosis removes between 92 to 96% of the dissolved phosphorus and 92 to 98% of the sodium, a blend of 50% reverse osmosis treated water and 50% untreated water would drop the dissolved concentrations in half. This may be based on local conditions and may allow unrestricted application to local fields for irrigation.

The detailed components incorporated into the overall process are made up from key process steps illustrated in FIG. 3 and FIG. 8, which represent on dairy farm tests as non-limiting examples. These tests were required to validate the performance of these selected pieces of equipment when applied to this unconventional application.

In one embodiment cleaned water, illustrated in FIG. 1, flow stream element 74 FIG. 1 is recovered from the wastewater by system 10 and it approaches water quality standards associated with non-potable water quality, and therefore does not trigger contaminated water discharge restrictions. Reference FIG. 8 Reverse Osmosis product water stream element 7. As a non-limiting example final cleaned water flow as indicated by element 74 on FIG. 1 can be ⅝ to ⅞ of the original waste stream flow element 24 FIG. 1. There are multiple reject streams coming out of system 10. If the use of a chemical metering system element 28 is used to enhance the lamella clarifier suspended solids removal of unit element 26 FIG. 1, the concentration of the suspended solids in reject stream 29 can be increased by 5 to 40%. Solids concentration in this reject stream can be between 1 to 6% solids by weight.

In system Subsystem 14, the sequential air assisted depth filters shown as elements 44 and 52 on FIG. 1 utilize compressed air to assist and minimize the use of water when required to backwash. Backwash is triggered by an accumulation of suspended solids on the surface of these depth filters which in turn exceeds a predefined cross filter surface pressure differential value, typically set from 5 to 10 PS 1G. Use of compressed air with pressurized water reduces the dilution of the suspended solids in reject streams elements 29, 48 and 54. Solids concentrations in these reject streams can be between 1 to 6% by weight. Use of chemical metering skid element 60 FIG. 1 to enhance the performance of the dissolved aeration flotation (see FIG. 5) unit element 58 and therefore increase the concentration in reject stream element 62 will again concentrate rejects. By increasing the solids concentration in these reject streams, the amount of material required to be handled is reduced, and the disposal or reuse options are expanded. With higher solids concentrations some of these reject streams can be added back to the dewatered suspended solids in flow stream element 20 from vibrating screen element 18 on FIG. 1.

In one embodiment these recovery ratios are achieved while applying normal recovery rates to each of the unit process steps employed during those field tests as more fully illustrated in FIG. 8. A recovery rate is defined as the percentage of final product (good cleaned) water generated as compared to the amount of water fed into that unit process step. In one embodiment unit process RO (reverse osmosis) Membranes are used. As a non-limiting example, and as illustrated in FIG. 8, a 30 gallon per minute discharge of clean water is achieved when processing 40 gallons per minute of raw infeed discharged from an ultrafilter by example. As has been stated earlier, Subsystem 12 can be installed without Subsystem 14 and Subsystem 16 reference FIG. 1. If Subsystem 12 and Subsystem 14 are installed such that the reverse osmosis associated with Subsystem 16 is excluded, the overall recovery of these 1st two sub systems will be greater. It is anticipated based on pilot test data, that the combined subsystem recovery rates will be closer to 80 to 90%. It should also be noted, that the reject streams associated with the sub systems are high value—added nutrient concentration streams that may in fact be worth more to the agricultural industry than the recovered clean water. By non-limiting example, the removal of contaminants from industrial wastewater flows may translate into significant reductions in existing wastewater penalties associated with excess TSS and BOD5 levels.

In one embodiment the overall nutrient concentration and water recovery system has expanded to include unit process steps illustrated in FIG. 3 and those from FIG. 8. The surge tank element 38 FIG. 1 may be substituted for by cleaning and designating an existing lagoon to serve the purpose of storing the high intermittent flow volumes discussed earlier. Depending on water analysis required to fully analyze waste water flow element 24 on FIG. 1, one less stage of depth filtration designated as element 52 may be required while still delivering the water quality in flow stream element 56. Unit processes elements 18, 26, 44 and 52 are required to deliver discharge water quality with less than 5-micron particulate size and low concentrations of suspended solids ranging from 500 to 3800 mg/L. at flow stream element 56 FIG. 1. If very fine suspended solids without potential for accumulation in storage lagoons is adequate or the final extraction of fertilizer nutrients is not required, then elements 58, 68 and 72 on FIG. 1 will not be required.

In one embodiment system 10, elements 44, 52 and 68 are available as standard capacity units. At the flow rates required by example in a barn flush installation, multiple units are installed in parallel and piped in a manifold configuration to handle the capacity. Often one additional unit is installed to provide partial backup or redundant operation and reduced process failure vulnerability. Elements 44 are by non-limiting example available in three standard flow ranges of 5-20 gpm, 20-100 gpm and 100 to 300 gpm. Flow ranges will be impacted by the TSS loading of the waste stream element 42. Elements 52 have flow ranges from 5 to 25 gpm subject to the TSS loading of flow stream element 46 as well as the micron ratings of the inserted filter media. System 10 can be added to existing front-end dewatering device such as unit element 18 FIG. 1 if already installed and operational at site. It-is assumed that in the case of an operating dairy, by non-limiting example, the farmer is already extracting the larger and heavier particulate from the waste stream with his existing dewatering device, prior to directing the liquid stream to this lagoon for storage or sequential series of lagoons for additional suspended solids settling in the 1st or 2nd of the sequential lagoons.

As elements 44 and 52 (FIG. 1) are installed in multiples, the foot print can be managed to suite the location. The footprint can be a square or a rectangle and the footprint can be reduced by stacking units vertically. Any stacked height over 4 feet, would reduce access to upper units. A 20 foot by 20 foot square up to a 20 foot by 40 foot would be required for the flow range stated above. This modular approach to installing adequate flow capacity, permits dedicating individual systems to specific waste streams and enables improved performance with fine tuning, higher nutrient recovery rates, further segregation of nutrients for different end purposes and potentially higher byproduct value, and the like. System 10 as depicted in FIG. 1 can be sized for either very large or quite small flow streams. In addition, by non-limiting example, system 10 as installed at an industrial site may or may not have surge flow retention capability. Element 38 may not be present, and Subsystem 12 FIG. 1 may not be sized for the large intermittent flows that typically occur on a dairy farm during barn flush activities. Therefore, it is possible to size the system 10 FIG. 1 for specific waste streams. In addition, the number of sequential subsystems from Subsystem 12 through Subsystem 14 and Subsystem 16 (reference FIG. 1) that are installed will be dictated based on the final water quality required in flow stream element 74 of FIG. 1. By example, —an industrial wastewater discharge may be trying to reduce BOD5 and TSS levels discharged to local municipal sewer districts. Subsystem 16 may not be required. From a practical standpoint, TSS levels may need to be less than 300 to 400 part per million (ppm) (or 300 to 400 mg/L) for compliance, instead of the 0 to 1 ppm exiting Subsystem 16.

In one embodiment system 10 supports an environmentally-friendly treatment of agricultural, industrial and food processing waste streams in order to remove the suspended and dissolved organic material. This creates concentrated N, P; K (nitrogen, phosphorous, potassium) based fertilizers and cleans up the waste stream.

In one embodiment a final water discharged in flow stream 74 on FIG. 1 has little or no organic matter than can be aerobically consumed in the lagoons. As the multiple filtration steps through Subsystem 12, Subsystem 14 and Subsystem 16 can extract the suspended solids and dissolved solids from the wastewater stream, the residual number of suspended solids left is very slight. Depending on which sub systems have been used, the total suspended solids concentration entering system 10 ranges from 15,000 to 30,000 mg/L and exits system 10 with virtually a nondetectable level of suspended solids. There is a very high correlation between suspended solids and the organic matter necessary to fuel the aerobic process in the lagoons. By non-limiting example, FIG. 8 shows a 18,000 mg/L pilot test system infeed and a 1 mg/L TSS level leaving the pilot test system and as a result methane off gassing is radically reduced.

In one embodiment system 10 includes a reverse osmosis unit on this waste stream that can reject chlorides. By embedding inside of the reverse osmosis unit element 72 FIG. 1 an additional reverse osmosis process unit on the reject stream element 76, sized for a much smaller flow rate with a very specific thin film membrane gram molecular cutoff for more exact molecular separation, the chlorides, sodium and the phosphorus nutrient can be separated out and chemically processed. In one embodiment phosphorus nutrient that is recovered can be a valuable fertilizer substitute. Phosphorus becomes problematic when it is applied in an “as is” condition along with the other concentrated nutrient streams. By separating it, the phosphorus can be added back in quantities such that the Nutrient Land Management Act acceptable levels are not exceeded.

System 10 can be utilized for several different applications, including but not limited to the following:

From Subsystem 12 FIG. 1, vibrating screen element 18 or equivalent dewatering device will yield dewatered solids between 12 to 20%. With incremental screw press on dewatered stream element 20 FIG. 1, solids levels between 20 to 35% can be achieved. This material can be sent to a composter for processing to generate fertilizer, or directly land applied based on seasonal requirements either on site or transported off-site. The dry matter can also be used as recycled bedding for the dairy herd. The rejects sludge from unit process 26 is discharged at between 1 to 6% solids. This sludge in flow stream element 29 can be blended with the dewatered stream element 20 for subsequent composting, recycled and directed to the front end of an anaerobic digester, or combined with other sludge streams to create a concentrated nutrient stream to be used as a fertilizer alternative.

Within Subsystem 14 FIG. 1, all the sludge streams from unit process elements 44 and 52 can be co-mingled, given their suspended solids content ranges from 1% to 6%. This material can be blended with the dewatered solids stream element 20 and forwarded to a composter. The material could also be recycled to the front end of an anaerobic digester or combined with other sludge streams to create a concentrated nutrient stream to be used as a fertilizer alternative.

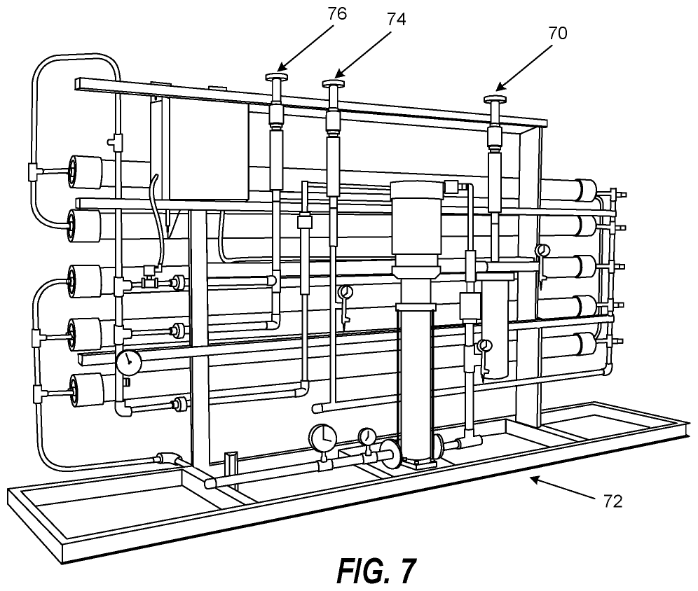

From Subsystem 16 FIG. 1, the rejects stream element 62 from unit process element 58 will have a solids concentration of between 0.3 to 2.5%. This volume of suspended solids can be recycled to the front end of an anaerobic digester or combined with other sludge streams as a concentrated nutrient. The reject stream element 76 from the reverse osmosis unit element 72 is a liquid stream. FIG. 8 indicates that the concentrate out of the reverse osmosis membrane system (see FIG. 7) as stream element 8 has potassium, ammonia and phosphorus which are a minimum of 20 times more concentrated than the nutrients in the product water element 7 FIG. 8 leaving the reverse osmosis skid Also see FIG. 7. With the chloride concentrations reduced as per the strategy described above with an additional reverse osmosis rejects stream skid installed on rejects flow 76 element in FIG. 1, the nutrients may possibly be applied as a fertilizer substitute.

The nutrients in reject stream element 76 can be blended with other reject streams to increase the overall nutrient content and marketed locally or used on farm.

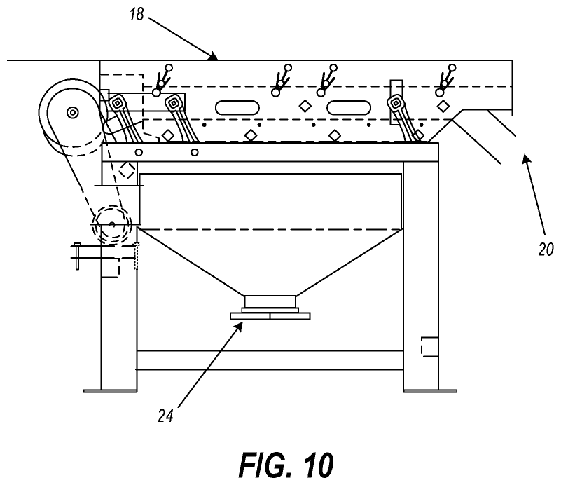

The vibrating screen shown as the element 18 of System 10 FIG. 1 is well-suited for a barn flush application on a dairy farm. Also see FIG. 10. Even though the dairy farm may be a concentrated animal feed operation (CAFO), with concrete as the primary surface upon which the dairy cattle walk, airborne sand and other inorganic material, as well as other organic materials within the animal feed accumulate and are present in the pumped barn flush water. As the vibrating screen does not use a compression zone to dewater like the Rotary drum screen press, the sand entrained in the waste liquid stream pumped by the farmer from the barn will do less erosion-based damage to the equipment. In addition, the vibrating action of the screen moves the dewatered fiber to the end of the screen and avoids blinding over. Water analysis of the waste stream will indicate whether an 80 mesh (1800 opening will be the best choice. Screens with mesh ratings down to 200 (750 are available but the limited open area of the screen makes the required screen surface very difficult to maintain. The best screen selection is a compromise between finer mesh ratings and the tendency of the screen to blind over and become plugged. Experience with 80 mesh vibrating screens on dairy manure has been successful to date.

In one embodiment if the feed source to system 10 of The Nutrient Concentration and Water Recovery Equipment FIG. 1 is from an upstream digester, the long retention time and the slow horizontal velocity component within the digester process settles out the inorganic sand. If the erosive sand has been removed up stream, and the anaerobic digestion process has removed 40 to 60% of the organically based suspended solids, a Rotary drum screen press would be a better alternative to element 18.

In one embodiment the screw press, or rotary drum screen presses can be utilized. In order to minimize the use of additional powered material transfer equipment, a Rotary drum screen press would be installed in an elevated configuration like the vibratory screen such that the dewatered product in flow stream element 20 can gravity fall onto pivot conveyor element 22 for delivery to storage pile accumulation. The waste liquid stream is pumped into the internal opening of the Rotary screen. The perforated screen is on an incline and the liquid dewaters through the perforated walls while the remaining sludge is move diagonally upwards by internal flites within the screen section. As the sludge drains, it also travels upward to the end of the screen by way of the flites and then discharges into the nip where two additional perforated drums come together and rotate in opposite directions. The sludge is drawn into the nip where the 2 counter rotating drums are within the fractions of an inch of each other. The sludge is pressed between the 2 rolls, and the liquid is pushed through the perforations of the drums, while the dewatered solids are discharged on the other side of the nip onto pivot conveyor such as shown on system 10 element 22.

In one embodiment system 10 requires little to no chemical addition. The chemical addition rate associated with metering flocculating agent into flow stream element 56 of FIG. 1 can range from less than 0.01 mg/L to over 1 mg/L. The chemical added is FDA approved. The final water quality is like non-potable water (higher quality to be subject to further laboratory verification) if cleaned and processed within Subsystem 16. FIG. 8 details the test trial results carried out in 2012-2013. As was stated earlier, when comparing the nutrient concentration of the reverse osmosis product water stream element 7 to that of the reverse osmosis (see FIG. 7) reject water stream element 8, the smallest concentrating factor achieved based on comparing the chemistry of both streams is greater than 20 times. This reject stream is in liquid form and as such can be transferred limited distances. This fertilizer material can be used in several applications. The dewatered solids in stream element 20 from the vibrating conveyor and/or equivalent shown as element 18 on FIG. 1 can absorb some of the medium consistency rejects from flow streams, elements 29, 48, 54 and 62. As discussed previously, concentrations of these reject streams are higher based on enhancing the suspended solids extraction of the depth filtration and clarifier and/or dissolved aeration flotation equipment (see FIG. 5). If the percent solids of the dewatered material leaving in waste stream element 20 remains above 15% to 17%, the material can be trucked away, or fed to an on-site composter for subsequent bagging and/or further drying through a screw press prior to bagging as a wholesale soil amender or fertilizer. Targets would include nurseries, large box stores, landscaping companies, as well as municipal landscaping maintenance operations. If the material achieves class a bio solids status by being at a high enough temperature for sufficient duration within the composter, the soil amender/fertilizer could be used for organic farming.

In one embodiment system 10 enables the original volatile organics in either the suspended solids or dissolved solids state, that have been extracted from the waste flow, to be retained and concentrated such that the volatile organics level can then combined with the reject flow stream element 76 discharged from the reverse osmosis (see FIG. 7) unit element 72 of system 10 as per FIG. 1. The high levels of suspended solids extracted by the many sludge settling, filtration, and clarification and/or dissolved aeration flotation (see FIG. 5) technologies within system 10 are confirmed based on the percent total solids of these reject sludge streams depicted on FIG. 1. Given the organic nature of the dairy waste or of the industrial food processing waste facility, the high-level of suspended solids also has a very high organic component. Volatile suspended solids represent the organic loading in the stream flow. A laboratory test was used to measure the organic loading of the flow stream(s). When looking at FIG. 8 which depicted the field test in 2012-2013 at a dairy and comparing the high suspended solids levels (TSS) rejected from the DAF, flow stream element 4, to the correspondingly high volatile suspended solids (VSS) in the same flow stream element 4, there is a high correlation as would be expected given the high organic inputs in either the dairy or and industrial food processing plant. This is also evident in the reject stream leaving the ultra-filter, flow stream element 6. There is also a discernibly higher di s solved organic loading in the reject's element 8 from the reverse osmosis as shown in FIG. 8. Therefore, a rich organic feed stream, optimal as a feed source for an anaerobic digester, can be made by blending the various reject streams elements 29, 48, 54, and 62 with the reject stream 76 from the reverse osmosis element 72 within system 10.

For a point of clarification, the term reject is typically used when filtration or other dewatering process is applied to a stream loaded with suspended solids matter and the suspended material is extracted. System 10 while in the process of extracting suspended and dissolved solids from the target waste stream, simultaneously and in this case sequentially cleans the target waste stream. The amount of nutrient extracted, and the exiting water quality is dependent on whether only Subsystem 12 is installed, or Subsystem 12 and Subsystem 14 are installed, or if all Subsystems are installed. Reject stream element 20 has a solids concentration of between 12 to 20% whereas the reject streams elements 29, 48, 54 and 62 have solids concentrations ranging from 1% to 6% solids dependent incoming water analysis, dairy herd feed if a barn flush application, or industrial food processing plant raw ingredients. Based on the percent solids and volume associated with reject streams elements 29, 48, 54 or 62 it may be most economic to blend one, some or all these reject streams with the large volume and significantly dryer dewatered solids element 20 leaving element 18 of system 10. This strategy may work well based by example on seasonal dairy herd feed rations. An alternate blending strategy may be better for another season of the year based on changing feed rations. Specifications as defined by customers for soil amenders may dictate a different combination of reject streams that yield a higher byproduct economic value.

In one embodiment system 10 provides use nutrient extraction equipment that provides for selectively adding system capacity as needed as has been detailed elsewhere. The depth filtration elements 44 and 52 as detailed on system 10 FIG. 1 are available in certain flow ranges. As was also stated, the actual flow rate of these units is dictated in part by the organic loading, TSS of the infeed streams such as elements 42 or 46 entering the filter elements. Therefore, the design capacity of system 10 to handle a specific flow stream volume combined with the organic loading of the stream will dictate the number of unit's elements 44 and 52 that need to be installed in parallel to handle the design volume. As these units are typically installed in a manifold with multiple units installed in parallel, the original installation would be more flexible if a manifold designed to accommodate more units at later date but not installed at this time, was installed. To a lesser extent, more capital-intensive equipment such as the initial dewatering device element 18, or the settling chamber and embedded clarifier 26 FIG. 4, or the dissolved aeration floatation/lamella clarifier 58 can be installed to accommodate future expansion. By example a vibrating screen element 18 with a smaller effective surface area to handle a smaller current flow rate could be incorporated now into the project. At a future date, when increased throughput capacity is required the nonfunctional blinded off area of the screen could be replaced with the appropriate mesh screen for additional capacity. Similarly, the reverse osmosis (see FIG. 7) unit element 72 could be designed and installed such that future reverse osmosis tubes could be in installed later and the tubes fitted then with more membranes to increase the throughput capacity.

FIG. 8 flow stream 3 shows a greater than two times reduction in TSS after the DAF (dissolved aeration floatation reference FIG. 5) trial unit process step. The dissolved aeration floatation (DAF) process injects small air bubbles into the target waste stream. The light suspended solids with or potentially without the addition of a chemical flocculating agent, tend to agglomerate to the rising air bubbles and form a scum on the surface of the DAF unit shown as element 58 within system 10. Reference FIG. 5 which is a general arrangement/flow diagram of a DAF unit. In the case of even finer suspended solids, a flocculating chemical is added which encourages the agglomeration of the fine suspended solids to the rising air bubbles. A traveling paddle system across the surface of the DAF unit moves the sludge to the discharge section of the DAF. The upstream dewatering device shown in FIG. 8 was unable to remove the finer suspended solids. The TSS as detailed by stream 1 (stream 1 and 2 were the same) into the DAF unit were dramatically altered by the performance of this unit to remove finer suspended solids, as reflected by the TSS numbers in flow stream element 3 which exited the DAF unit of FIG. 8.

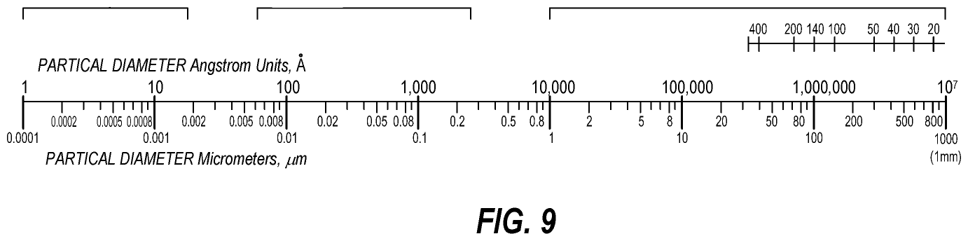

In one embodiment BOD5 levels in flow stream element 3 of FIG. 8 can range from 4000 mg/L down to less than 1000 mg/L BOD5 is a laboratory measurement of the propensity of the material within the waste stream to preferentially consume dissolved oxygen within the watershed for aerobic digestion. It is the small suspended solids material or the dissolved solids which most directly affect BOD5. activity levels. It will be the lamella clarifier or equal with possible chemical addition indicated as part of element 26 within system 10 on FIG. 1 or the dissolved aeration floatation (see FIG. 5) or lamella clarifier indicated as element 58 within system 10 or the reverse osmosis (see FIG. 7) element 72 which will extract the smaller suspended solids material or dissolved solids and thereby reducing on BOD5. Reference FIG. 9 which details the particulate filtration scale. On that FIG. 9, you will notice which membrane filtration types are best suited to process or remove different particulate sizes. By example note that the size of the sugar molecule is best handled by reverse osmosis (see FIG. 7). As the reverse osmosis c an deal with the very small organic compounds which tend to aerobically digest quickly, their removal before reaching the watershed would have a positive effect on BOD5.

Settling and depth filtration remove suspended solids and achieve corresponding reductions in TSS, VSS and BOD5. The vibrating screen as indicated by element 18 in system 10 removes the majority of the suspended solid, by non-limiting example from the dairy barn flush waste stream. This is evidenced by the dewatered solids removed at that unit process reaching concentration levels of 12 to 20% solids. Although the 80 it screens typically used on a vibrating unit is rated at 185 lu., this is still the larger particulate within the dairy barn flush waste stream. See FIG. 10 for a picture of a typical unit. The smaller the particle size of the suspended solids material, the more challenging is the removal process. The settling chamber depicted by element 26 FIG. 1 slows down the horizontal velocity of the flow stream in order that the vertical settling velocity is generally, as defined by Stake's Law and fluid dynamics, faster thereby settling out suspended solid in the flow stream element 24 FIG. 1. The embedded lamella type clarifier embedded within settling chamber (Reference FIG. 4), may use chemical flocculant to cause the suspended material to agglomerate and therefore manipulate the agglomerated material to settle out of the flow stream more readily. The suspended solids concentration in the reject stream 29 leaving element 26 can range from 1 to 6% solids. By manipulating the flow stream and the settling chamber and manipulating the apparent size and weight of suspended solids, concentrations can increase to 4 to 6%.

The depth filters depicted by element 44 and element 52 can extract suspended solids such that the sludge leaving in reject streams 48 and 54 can range from 1% to 6% solids. By utilizing compressed air, as opposed to more backwash flush water, the concentrations in the reject streams can climb to 3 to 6%. It should be noted that depth filtration as shown on FIG. 1 is sequential with regards to reducing particle size. Element 44 would typically remove particulate 100 it or greater, while depth filter elements 52 may again be progressive and particulate may range from 100 it down to 50 its, with the final stage of depth filtration removing particulate from less than 50 it down to equal or less than 5 it. By means of comparison, a typical human hair is 75 i.t. in diameter.

In one embodiment a vibrating screen can be fitted with mesh sizes ranging from 40 mesh (400-0 to an excess of 200 mesh (75 1.1). See Figo based upon operating data, vibrating screen mesh size needs to consider the effective open area of the screen and therefore the corresponding surface area of the vibrating screen, as well as the potential for the screen to blind over or become plugged. Although 30 and 40 mesh screens have been used to dewater dairy barn flush water, better solids removal rates have been achieved and not at the expensive of more plugging potential based on using an 80-mesh screen.

The settling chamber and lamella clarifier as per FIG. 4, illustrated as element 26 on FIG. 1 for system 10, remove the smaller particle sized TSS organic matter when compared to the vibrating screen element 18. As detailed above the range of concentrated suspended solids in the reject stream element 29 can be impacted by the nature of the particulate in the barn flush water resulting from the animal feed rations delivered to the dairy herd as well as whether any level of chemical flocculant is added at the lamella clarifier unit. the range of within this reject stream can be from 1 to 6%.

In Subsystem 14 FIG. 1, TSS is filtered to a 51μ particulate size level. Organic based suspended solids leaving Subsystem 14 as represented by flow steam element 56 FIG. 1 will have between 100 to 1000 mg/L concentration. The total suspended solids levels within flow stream element 56 were higher due to a large fraction of fly ash. This was confirmed by lab analysis. It was discovered that the farm used fly ash for road and earth stabilization in the event of rain. Fine light fly ash would have been airborne and fouled the lagoon and barn flush water over time.

In one embodiment illustrated in FIG. 3 represented the on-site dairy testing configuration of the automatic backwash filters elements with air assist to minimize dilution of reject streams. These automatic back washable filters are depicted on FIG. 1 as elements 44 and 52 Test samples were taken at locations as indicated on the process flow sheet of the test configuration as shown on FIG. 3. Jar test type samples were also taken after the 2nd depth filter equipped with a 5-μ filter element. No visible settled solids or suspended solids in the flow leaving the filter were evident and this was also the case after the samples were left undisturbed overnight. The jar test samples were slightly opaque with a slight green-gray tint. This confirmed that no meaningful solid accumulation would occur if the flow stream element 56 as per FIG. 1 were directed into the lagoon(s). Given the organic loading in the samples tested after the 51μ filter were less than 0.1 mg/L, off gassing associated with biogas from aerobic digestion of organic material directed to the lagoons would be minimal to nondetectable. The laboratory testing of the samples taken at that same location confirmed a higher value for inorganic suspended solids. As this material also passed the 51μ depth filter, it would not be predisposed to settle out. Secondly given that this material was tested to be inorganic in nature, it would make no contribution to any lagoon off gassing. Reference the lab results for the flow stream element 7 discharged from the reverse osmosis shown on FIG. 8 and specifically the volatile suspended solids (VSS) result. It should be noted that if system 10 included Subsystem 16, there would be virtually no organic matter in accept stream element 74 from the reverse osmosis (see FIG. 7) unit process element 72. Therefore-there would be no off gassing from that source. There may however be off gassing based on residual material in the lagoon that was directed there prior to installing system 10 FIG. 1.

In one embodiment, treated waste stream discharged from system 10 is cleaned to a level where it can be land applied or reused for all but potable water purposes. Lab test results for total suspended solids, total dissolved solids, volatile suspended solids, BOD, sodium, chlorides and the nutrients, P, Nandi K, were generated. Please reference FIG. 8. which illustrated field testing carried out in 2012-2013. Results for stream element 7 of FIG. 8 confirm water quality, for the variables sampled equal to the water quality levels established for non-restricted irrigation waters, as well as potential for watering livestock. As the testing was focused on the recovery of nutrients from waste water streams, testing for other inorganic contaminants or heavy metals was not the focus of the trial of that time. That still needs to be done to confirm the quality level of the cleaned water.

In one embodiment system 10 includes a sequential series of unit process steps to treat the waste stream from certain organic sources, including but not limited to, restaurant and organic waste and effluents from industries such as breweries, grocery stores, food processing plants, granaries, wineries, pulp and paper mills, ethanol and biodiesel plants, agricultural field crops, organic sludge accumulation within lagoons and waterways, marine organic matter and animal manure. Stage 1 Detailed as Subsystem 12 on FIG. 1 represents the initial wastewater treatment system dewatering equipment element 18 as well as a combination suspended solids settling tank and integral lamella clarifier (see FIG. 1) element 26 with discharge to either a surge tank or repurposed and designated lagoon 38. Incorporated into this Subsystem 12 is a chemical metering skid element 28 in order to enhance the suspended solids removal performance of the lamella type clarifier and a sludge tank element 32 with appropriate controls element 34 and sludge handling system pump element 36. There is also located after surge tank element 38, a transfer pump element 40 which pressurizes the accumulated intermittent flow volume and transfers downstream to 2nd stage detailed as Subsystem 14 on FIG. 1.

This Subsystem 12 of the overall Nutrient Concentration and Water Recovery system 10 for more continuous waste stream flow rates from industry is not sized to handle peak flows as was the case for the intermittent barn flush activity. By non-limiting example, the markets served and listed above could result in more continuous flow rates in the subsequent downstream Subsystem 14 and Subsystem 16, identified on FIG. 1. System 10 could be sized from 5 gallons per minute to over 1000 gallons per minute based on specific applications. In addition, the suspended solids removal equipment element 26 located after the vibrating screen or equivalent element 18 is necessary to remove a substantial fraction of the suspended solids entering system 10. By removing between 40 to 90% of the TSS within incoming water at this point in the process maintenance associated with cleaning out either the surge tank element 38 or dedicated on-site lagoon is reduced. In addition, with a large portion of the settleable solids removed at this point in the process, the waste water quality would be improved allowing for greater recycling of this water, more nutrient material extract to be used as a fertilizer substitute, or dried and sold as animal food supplement subject to testing or discharged without sewer charge penalties to the local sewer district.

Subsystem 14 on FIG. 1 represents the 2nd stage of the wastewater treatment system. Subsystem 14 includes a series of sequential automatic depth filters. Units can be equipped with progressively finer i.t. rated filters. Unit process element 44 has an internal recirculating loop required to maintain filtration efficiencies. By cleaning the recirculated flow with centrifugal separator element 50 or equivalent, recirculated organic TSS material can be continually bled away from the system thereby reducing the amount of TSS material subject to fiber breakdown due to traveling through the recirculating pump. This ensures that suspended material is removed rather than reduced in size and therefore transferred downstream to be removed by finer i.t. rated depth filtration. As in the Subsystem 12, there is a common sludge removal system including a sludge tank element 32 with level controls element 34 and the sludge discharge pump element 36. Subsystem 14 is sized for a continuous flow. As final depth filtration which includes unit element 52 are rated down to 5 i.t. with actual particulate removal ranging from 5 to 31.1., any residual TSS does not pose a settling problem in any of the on-site lagoon(s) or other storage tank. Reject streams elements 54 and 48 due to their similar characteristics are by non-limiting example, co-mingled in the sludge tank element 32. Reference FIG. 3. In addition to the laboratory analysis, an industry standard jar type test was performed on the water quality exiting the pilot test equipment represented by FIG. 3. After an overnight settling period, there was no evidence of either suspended solids or settled solids in the jar test. Based on these results, the lab results and the absolute filtration rating of unit's element 52, very limited settling is anticipated in any of the lagoons on-site. This in turn minimizes lagoon maintenance, the potential for final lagoon liner damage associated with use of heavy sludge removal equipment, as well as minimal off gassing due to minimal TSS loading which would include minimal organic material.

Subsystem 16 as shown in FIG. 1 is the final stage of filtration, nutrient removal and water recovery in system 10. The components within this Subsystem 16 incorporate many of the pilot test components used during the on dairy farm testing in 20 Subsystem 12—2013, FIG. 8. Again, as in the case of Subsystem 14 FIG. 1, the hydraulic loading for this subsystem, could range between 5 gallons a minute to 1000 gallons a minute. Based upon minimal TSS loading after the 51μ depth filter units' element 52, a dissolved aeration floatation unit element 58 complete with flocculating chemical addition by chemical metering skid element 60, would reduce TSS loading in the accept stream element 66 such that the final in-line cartridge filters element 68 could remove any residual suspended solids.

Sludge removed from the feed stream element 56 FIG. 1 as shown in reject stream element 62 would be collected in sludge tank element 32 with level in the tank controlled by level control element 34 which would activate sludge discharge pump element 36. The water quality as per flow stream element 70 FIG. 1, would be suitable as reverse osmosis (RO) feed water. The reverse osmosis (see FIG. 7) unit is included in system 10 FIG. 1 if the final water quality leaving the system needs to be at a water quality level not restricted by any EPA discharge criteria. It is expected that this water subject to further testing will be equivalent to non-potable water. The incremental benefits of the reverse osmosis system are the removal of any elevated chlorides within flow stream element 70 as well as any elevated phosphorus levels. Phosphorous due to its very stable nature and slow pickup by crops is usually the nutrient that exceeds Nutrient Land Management Act levels. Because of the cost of reverse osmosis element 72, a smaller reverse osmosis system not sized for the full process flow element 70 may be installed.

This is possible because the chloride and phosphorous levels are so reduced going through the reverse osmosis that a blended strategy with water not treated by a reverse osmosis (see FIG. 7) system can be utilized and therefore the capital cost of the overall nutrient concentration and water recovery system 10 can be reduced. By example, the cleaned product water leaving FIG. 1 Subsystem 16 element 72 could be automatically chlorinated and used as nothing more than a floor wash down water in a food processing plant. More testing would be required to determine if the FDA would accept “higher uses” of this recovered water, by non-limiting example incoming raw food wash-down.

In one embodiment system 10 improves the extraction of the desirable fertilizer components found within these waste streams, including but not limited top −N −K. In one embodiment the system provides a nutrient concentration and water recovery process illustrated in the FIG. 1.

As a non-limiting example system 10 can be used to remove suspended solids that have the potential to foul the reverse osmosis unit process step. Reverse osmosis (see FIG. 7) uses osmotic pressure across spiral wound membranes to restrict the flow of specific molecules while allowing other molecules to pass through the membrane. The depth filter units indicated as elements 44 and 52, by contrast capture all suspended material as they attempt to pass through the filter element. Backwashing these units drives the surface trapped material off the depth filter such that it can regain its flux rate (flow rate per square area of filter element).

By contrast, reverse osmosis membranes cannot be back washed without doing major damage to them. Therefore, reverse osmosis cannot be subjected to suspended solids. The final cartridge filters are there to provide protection. If there are high chlorine levels in the water fed to the reverse osmosis, an activated carbon filter element may be required and could be installed with the cartridge filters or as a substitute. As a non-limiting example, a DAF or lamella clarifier with potential chemical flocculant addition can be used to replace a very expensive ultrafilter or centrifuge if the TSS if levels are less than 4500 mg/l. Initial water quality will confirm the need for element 58 on FIG. 1. Waste water quality combined with a more suspended solids tolerant reverse osmosis system, has potential to remove the need for element 58. The reverse osmosis (see FIG. 7), with more frequently programmed flush cycles and the use of 2μ cartridge/bag filtering media in element(s) 68 upstream to protect from suspended solids will be used to maximize the potential of removing element 58 from system 10 FIG. 1.

In one embodiment in dairy operations the selection takes into consideration density and size of the suspended particulate which in turn are dependent on the feed given to the dairy cattle and the dairy breed.

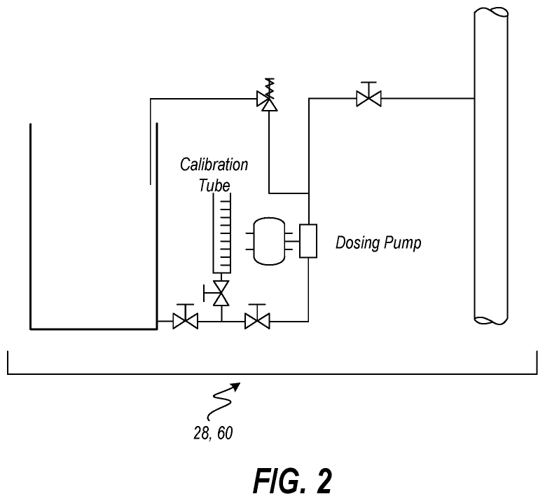

In one embodiment if chemical addition is required for system 10, automatic metering is used and requires only limited operator monitoring and intervention. FIG. 2 provides a schematic of a typical chemical metering skid. Dosing will be light and can range from 0.01 mg/L to 1 mg/L of system flow rate.

It should be noted, that FIG. 1 represents a multi sequential step process. As such the overall performance of the process is not tied to one-unit process as in other waste treatment plants where by example the only treatment step is clarification. As such, continuous fine tuning of chemical metering is not as critical in the process as defined by FIG. 1.

In one embodiment system 10 can be used to recover nutrients from agricultural facilities or industrial food processing plants when the waste constituents can be organic in nature. High organic loading levels associated with food processing plants as well as abandoned lagoons, or contaminated watersheds due to the accumulation of flood damaged waterways, could use an embodiment of system 10 to extract and manage excessive organic waste contaminants. As such the recovery of these nutrients in separate and discreet waste streams and their reapplication to land as fertilizers without toxic implications is achieved because the concentrated reject streams can be controlled and diluted to target values which do not exceed Nutrient Land Management Act levels. Any concentrated nutrients within the reject streams in excess of the amounts required to comply with the Nutrient Land Management Act for the onsite farm applications can, can be shipped off farm to locations where they can be sold as organic soil amenders and/or substituted for chemically based fertilizers. In one embodiment the raw material treated has only organic contaminants sourced from agricultural and/or industrial food processing waste streams. By removing these organic suspended or dissolved components the aqueous portion of the waste stream can be cleaned up such that it can be discharged either on the fields or into watersheds without harm.

In one embodiment heavy metal contaminants present are removed at the reverse osmosis (see FIG. 7) unit process step. Reverse osmosis thin film membranes typically used in wastewater treatment require relatively low inlet feed pressure to perform. They can selectively remove certain nutrients such as nitrogen, phosphates and potassium as well as some heavy metals and contaminants. The presence of contaminates such as lead, or mercury may also be found at some sites. Other contaminates may also be dissolved in the water and therefore in the waste water stream. Water analysis is required before system technology is applied. Because the selection process is dissolved molecule size dependent, both nutrients and contaminants may be co-mingled in the reject stream, thereby rendering the nutrient value of the reject stream nothing. By non-limiting example the appropriate membranes for nutrient recovery would remove 95 to 98% of the phosphates and 92 to 96% of the potassium. However, the same membrane may reject or concentrate 95 to 98% of the lead as well as 94 to 97% of the mercury.

In one embodiment if the waste stream is contaminated with only suspended and dissolved solids that are organic in nature, such as barn flush water, anaerobic digester digestate, or industrial food processing waste water, the nutrient concentration and water recovery process is applied. The methods within system to avoid diluting the reject streams and therefore concentrating the organic and nutrient values in Subsystem 12, Subsystem 14, and Subsystem 16 have been discussed above.

In one embodiment waste streams, including those for industrial and food processing plants, can differ based on regional water quality, type of agricultural waste; hog or dairy, as well as the seasonal variations in agricultural feed ingredients. Although all chemical s added during processing and used in industrial food processing plants must meet FDA requirements, there can be variability from food processing plant to food processing plant as well as from production line to production line. This can cause changes in percentages of suspended solids, particle size distribution, and percentages of dissolved solids and the relative volumes and concentrations of the dissolved material. All these things can change the required flow rates in the various unit process steps, the recovery percentages of each unit process, and therefore the sizes of the various unit process equipment. Suspended solids from a food processing plant which handles potatoes could have TSS levels of 5 to 25,000 mg/L. Particulate size can range from small starches near 5 i.t. up to particulate at 400 to 500 i.t. Total dissolved solids in such a process can approach 5000 to 10,000 mg/L. Waste water analysis is the first step is critical. In one embodiment system 10 FIG. 1 has used 3 sequential stages to recover all available nutrients and reclaim water within the waste stream to the highest quality (least contaminated) level. In one embodiment each of these stages has multiple unit process steps incorporated.

In one embodiment system 10 as depicted in FIG. 1 uses three sequential stages referred to as Subsystem 12, Subsystem 14, and Subsystem 16. The focus of the first subsystem 12 is to remove the larger suspended solids. In the case of high but intermittent flow rates such flow streams element 24 as in the case of CAFO barn flush, components may be sized to handle maximum flow rates associated with the periodic but non-continuous flows. As a non-limiting example, dairy barn flush flows can be up to 1500 US gallons per minute based on normal flush practices for a three thousand head dairy housed in multiple discreet barn structures. However, by distributing the barn flush activity from three 1-hour duration flush cycles for all barns as reflected above to twelve 1-hour duration flush cycles involving less barns during each flush, dairy barn flush flow rates can be reduced by a factor of 4. As a non-limiting example, the flow rate can extend over a one-hour period. To better use capital investments, subsystem 12 FIG. 1 can be designed for this flow rate prior to accumulation with either a surge tank and/or an onsite lagoon recommissioned as a cleaner liquid storage lagoon or the farmer's barn flush reception pit. As a non-limiting example, the volumetric capacity of the surge tank or “repurposed” lagoon can be 90000 gallons. A more cost-effective strategy would be to distribute barn flushes over 12 cycles in order to reduce the size of the surge/flush volumes such that existing barn flush reception pit could handle this volume and then meter out a lower steady continuous flow rate of 95 gpm over the two hours between each barn flush cycle. This allows for the reduced sizing of the unit process steps/equipment represented in sub systems Subsystem 14 and Subsystem 16. The intervening time between barn flushes as stated above reduces the surge storage capacity requirement as well. This by no limiting example could reduce the process flow capacity of the subsequent unit process steps downstream from 1500 gallons per minute to 195 gallons per minute.

In one embodiment unit process element 26 in Subsystem 12 as depicted in FIG. 1 can include a pre-settling chamber with modified features to drop out the larger settleable solids. In one embodiment waste water analysis is required to determine if an incremental step such as an imbedded lamella clarifier (see FIG. 4) is needed to reduce suspended solids to a level where suspended solids accumulation in either the downstream surge tank or the repurposed clean lagoon is minimized. In this way, heavy equipment is not required for settled solids removal and/or infrequent wash down to drain. Pump out is a feasible and non-damaging alternative. In one embodiment unit process element 26 can be installed as a settling chamber only.

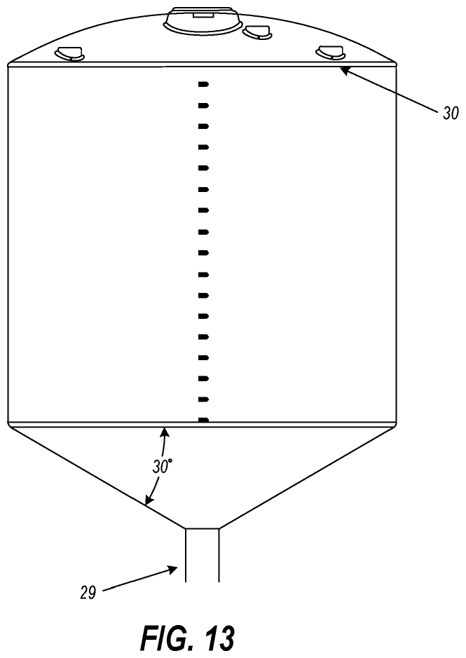

In one embodiment by installing the dewatering device process unit element 18 as shown in FIG. 1 upstream of and above a large closed top poly tank see FIG. 13 positioned inside either the surge tank or designated lagoon and placed horizontally, retention time and settling suspended solids velocities can be used to remove a large fraction of the settleable TSS before the TSS laden waste water is allowed to deposit the suspended solids into either the surge tank or the designated onsite lagoon. Based on specific TSS conditions, this novel configuration could avoid the capital cost of flow element 26 as shown on FIG. 1 and detailed in FIG. 4. By fitting this tank with positive displacement pump(s), accumulated settled solids can be removed from this “stilling chamber” and handled as flow stream element 29 in FIG. 1. The primary flow from the upstream device 18 FIG. 1 would first flow into this poly tank for settleable solids removal prior to overflow into the surge tank element 38 or equivalent. In the case of a barn flush, a low-level sensor signal in the surge tank element 38 would also indicate completion of the barn flush and control operating time periods for the positive displacement pump(s) timer-based operation while ensuring contained settled solids are not discharged to the surge tank element 38. Depending on raw water characteristics, this tank-in-a-tank process design would minimize long term solids accumulation in the surge tank and permit use of other than heavy machinery as detailed above for periodic cleaning of surge tank element 38 or equivalent. In addition, it would represent a low-cost alternative to the fractionation settling tank (see FIG. 4) assembly element 26.

As a non-limiting example if there is a need for an incremental step to reduce suspended solids accumulation in either the downstream surge tank or the repurposed clean lagoon to meet acceptable settled solids accumulations in the surge tank element 38, then an imbedded lamella clarifier could be added. Lamella clarifiers yield a large effective surface area. This permit installing the lamella clarifier into a small footprint within the settling chamber element 26. As a non-limiting example, limited chemical addition may be required to extend the clarifier effectiveness to smaller and less dense suspended solids. It is intended to reduce suspended solids concentrations in flow stream element 30 to less than 1%.

In one embodiment Subsystem 14 includes unit process steps elements 44 and 52. Each of these sequential filtration steps is progressive. In one embodiment there are initially 3 levels of depth filtration: starting with the largest particulate size ranging from 200 it down to 50 it and the 2nd progressive stage stepping down from 100 it down to 20 it and the final stage ranging from 50 it down to 5-it particle size filtration. Each of these filtration steps has multiple units operating in parallel. As such, parallel units are installed for capacity, but also yield redundancy and therefore more process uptime.

In one embodiment sequential filtration steps in unit process element 52 utilize the same filter body housings. System 10 can utilize different particulate filter sizes. The filter elements include 400-it, 200-it, 100 it, 50 and progressively down to 5 it. A change in filter size can impact the flow capacity of the filter element and therefore the filter assembly and potentially the number of filters installed in parallel. As the filter body assemblies are the same and only the internal filter elements change, it is possible to make process changes during operation. This provides great flexibility to respond to changes in the waste water being treated.

In one embodiment, the sequential filtration steps in unit process elements 44 and 52 improve their respective backwash functions in a number of ways: (i) as the back wash per unit process is initiated based on a pressure differential signal measured across the depth filter, the monitoring and cleaning function is automatic; (ii) As the differential pressure signal can be adjusted, the frequency of backwash can be adjusted to compensate for a change in the waste water characteristics. It can also be adjusted if a greater buildup of suspended solids on the depth filter yields a lower TSS discharge water quality.

In one embodiment, the sequential filtration steps in unit process elements 44 and 52 use compressed air to assist in the backwash function. This is beneficial to the process. By using compressed air, less water is used in the backwash function and consequently the reject stream is less dilute. Transportation costs are reduced. As a non-limiting example all reject streams are discharged to small interim poly storage tanks element 32 FIG. 1. The tanks are closed top but not pressurized. Level control as illustrated by element 34 FIG. 1 is provided for both remote monitoring as well as to signal tanker vehicle to pickup of contents.

By discharging rejects into interim closed top rejects storage tanks element 32, much of the nitrogen is retained. Given nitrogen's tendency to disperse into the atmosphere as a gas and dissolve into the water, the nitrogen captured in the TSS that has been removed from the waste stream and stored in the closed storage tank will off gas from the TSS sludge until a partial pressure above sludge reaches equilibrium as per Dalton's Law of partial pressures. With limited air circulation into the storage tanks, beyond pressure relief vents, the nitrogen gas will stay in the tank and therefore slow/reduce the further off gassing of the nitrogen rich sludge.

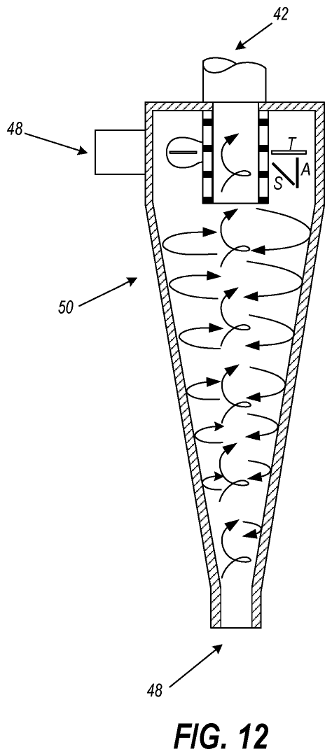

In one embodiment unit process element 44 is equipped with a centrifugal separator element 50 FIG. 1. See FIG. 12. This unit is added to remove TSS recirculated, which is required to maintain flow rates across the filter elements. In addition, by removing the TSS prior to recirculation, any particle damage or size reduction associated with going through the recirculation pump is minimized. The centrifugal separator element 50 within Subsystem 14 on FIG. 1 shows the relative position of this device within the recirculating loop around depth filtration element 44. A chambered valve configuration dumps accumulated solids without continuous liquid discharge and subsequent rejected TSS dilution.

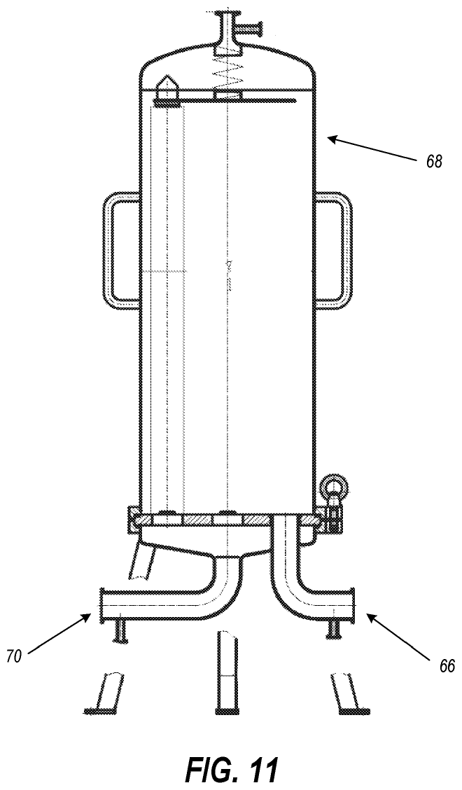

In one embodiment, Subsystem 16 FIG. 1 can include unit process steps elements 58, 68 and 72. Subsystem 16 is included in the overall process in order to remove all residual TSS such that reverse osmosis (see FIG. 7) can be used to extract the remaining nutrients and the phosphorus and chlorides which due to their presence may otherwise limit “unrestricted discharge” of the final water stream element 74 as depicted on FIG. 1. As flow stream element 56 as shown in FIG. 1 can be filtered such that any remaining TSS is less than 5ii, residual TSS will require alternative removal methods. In Subsystem 16, each of these sequential remediation steps is progressive. In one embodiment there are initially 3 levels of cleaning. As the TSS loading levels in this flow stream element 56 FIG. 1, are still too high to use inline cartridge filters (see FIG. 11) at this point, other options include centrifuges, ultrafiltration, clarification or dissolved aeration floatation (see FIG. 5). In one embodiment clarification or dissolved aeration floatation can be utilized. As a non-limiting example, water analysis of flow stream 56 can be used to determine which is the better option. Given the small sized particles in flow stream element 56, a small dosing volume of flocculant may be required. Dosing levels ranging from 0.01 to 1.0 mg/l may be required. As the dosing is performed by an automatic metering system and given the FDA compliant chemical costs are minimal for the anticipated dosing, the increased operating costs do not offset the increased capital costs of other options such as centrifuge or ultrafilter.

In one embodiment the rejects from unit process element 58 can be handled in the same way as in Subsystem 14. By discharging rejects into an interim closed top rejects storage tank, much of the nitrogen is retained. Given nitrogen's tendency to disperse into the atmosphere as a gas and dissolve into the water, the nitrogen captured in the TSS removed, and stored in the closed storage tank will off gas from the TSS sludge until a partial pressure above sludge reaches equilibrium as per Dalton's Law of partial pressures. With limited air flow into the storage tanks, beyond pressure relief, the nitrogen gas will stay in the tank and slow/reduce the further off gassing of the nitrogen rich sludge.

In one embodiment inline cartridge or bag filter units can be utilized after unit process element 58. There will be multiple units installed in parallel to permit manual change out of cartridge filters when they have signaled a change out of bag filter due to exceeding the differential pressure set point and subsequently triggering an alarm. In one embodiment to ensure system uptime, given the complete system is not staffed 24 hours per day, additional parallel units can be installed? In one embodiment light TSS loading leaving unit process element 58 result in cartridge filters acting as emergency process protection for the downstream reverse osmosis (see FIG. 7). In one embodiment a final TSS in flow stream element 70 as per FIG. 1 can be <1 ppm. In one embodiment bag filter replacement does not generate a sludge type reject flow from this element 68unit process. Bag filters within the bag/cartridge filter housings are typically removed and replaced.

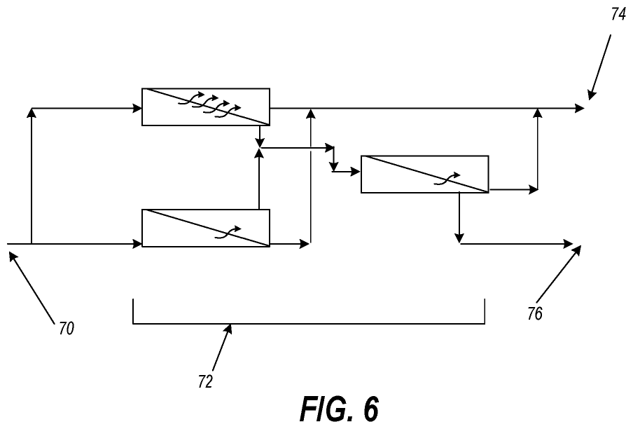

In one embodiment the next unit process in Subsystem 16 is element 72 FIG. 1, the reverse osmosis (RO) process. In one embodiment a 2-stage reverse osmosis configuration can be utilized as shown in FIG. 6 and FIG. 7 can maintain a high recovery rate without excessive pressure drop. Avoiding the high-pressure drop would reduce the connected horsepower required to run the boost pump feeding the reverse osmosis element 72 FIG. 1. By comparison thin film membranes used in RO will require upto 150 psi supply pressure. It is anticipated that with good design, the in feed into the system would be less than 100 PSI. In one embodiment based on infeed water analysis, an automatic anti-scaling chemical dosing skid can be used. There are no suspended solids in the reverse osmosis reject stream designated element 76. This flow stream with a virtual absence of suspended solids can be treated as a liquid. It can be collected and used with irrigation/syphon systems dependent upon the dairy farmer's best and highest use for this material. It can also be combined with all the other reject streams (elements) 29, 48, 54, and 62 to become a concentrated nutrient stream for sale or use as an on-farm fertilizer alternative.

In one embodiment when the chloride and sodium concentrations in a flow stream element 76 are high, their removal is required. Reference FIG. 8 flow stream element 8. Without removal, the other nutrients may not be available for land fertilizing. A small incremental reverse osmosis unit built into the primary RO as part of the reject stream element 76 FIG. 6 would be sized and designed for the smaller reject stream leaving the primary osmosis skid. This would be a RO configurations variation as shown on FIG. 6. This unit would only be used to reduce contaminates listed above to levels acceptable for land application or simple non-hazardous disposal.

In one embodiment the overall process flow capacity of Subsystem 16 may not match that of the previous two stages. On a per gallon basis, water treated in Subsystem 16 FIG. 1 is the costliest. Based on site conditions, the demand for this level of clean water may be limited. As a non-limiting example, further testing is needed to determine if the FDA will accept this water quality to displace OP (clean in place) water used in the milk parlor. In addition, this clean water can be used to dilute the chemical buildup in the recycled barn flush water. If barn flush water is treated to a Subsystem 14 FIG. 1 level by example, TSS has been significantly reduced to allow for barn flush, but each reuse will accumulate the level of dissolved chemicals. In one embodiment some cleaned Subsystem 16 discharge water designated as element 74 water may be used to dilute and extend the number of reuse cycles such as barn flush water. Subsystem 16 cleaned water quality will be site specific as indicated by analysis of source water.

FIG. 9 illustrates an embodiment of particle sizes which can be a removed by the most effective filtration/membrane technology. System 10 can include dissolved and suspended solids. In one embodiment system 10 and can execute several process steps to precondition target material.

In one embodiment it is possible to specifically pick process technology targeted for each of the size range classifications of particulate in the waste stream in question. The process as generally depicted in FIG. 1 and represents this system approach. All unit process components are selected and placed within the overall process. In one embodiment the following criteria are used for the selection of unit process steps shown in FIG. 1:
(i) largest suspended solids removal first and the removal of process equipment damaging inorganics including sand;
(ii) consider all EPA related constraints and design process to achieve overall compliance with
(iii) selective particle size filtration, minimize or avoid solids accumulation in the process(s) that would require periodic cleanup;
(iv) reuse of site facilities including installed dewatering equipment and substitution of a designated existing lagoon for a surge tank;
(v) the overall process can have any number of subsystems depending on acceptable project paybacks and overall affordability;
(vi) a high concentration of reject streams can be used to expand reuse options such as adding to the primary dewatering solids pile without increasing liquid fractions to the point where trucking becomes environmentally complicated;
(vii) a high concentration of reject streams can be used to increase by-product value;
(viii) automated unit processes can be used, including but not limited to automatic backwashing of depth filter unit processes, to reduce operator intervention and costs;
(ix) multiple sequential unit process steps can be consolidated into less or more cost-effective process steps; and,
(x) more progressive and advanced technology can be used.

As a non-limiting example pumping waste material requires some specific design features in the piping associated with transferring the flows with higher solids content, as well as the lines handling higher urea concentrations. In the case where higher solids content flows stop and start, there is a high potential for settling of solids out of the flow stream and consequential line plugging. A low point drain feature as well as “cleanout flush elbows” represent effective handling strategies. Their location(s) as well as the number can be dependent upon the concentrations of the fluids handled and other site-specifics.

In one embodiment further incremental design requirements can be installed at locations of high urea. In one embodiment non-rigid piping such as pressure rated flexible tubing or hoses can be used in order to minimize the precipitation of struvite. (NH4) MgPO4·6(H20) and at molecular weight of 245.41 gm can drop (precipitate) out of solution and crystallize on rigid wall structures associated with the piping system. The precipitation of struvite can result in crystalline structures forming within the inside of rigid and fixed equipment such as pipelines etc. If left unmanaged, this material can over time restrict and ultimately plug some of the pipelines rendering the system inoperable.

In order to avoid operating problems associated with pipeline plugging, include all the following piping design strategies and process operating conditions in the de sign of skid piping and interconnections between unit process steps: maintain liquid velocities, control pH levels, avoid low turbulence piping designs and install replaceable elbow sections in areas subject to high abrasion from inorganics such as sand. In addition, it should be noted that gravity discharge from one-unit process to the next minimizes piping related operational problems and system plugging which in turn reduces unintended downtime.

As a non-limiting example, level sensors as depicted by element 34 FIG. 1 can be utilized with a system controller such as a PLC (central programmable logic controller) and can log the number of fill cycles and therefore totalize each of the discreet reject streams. This may be necessary for inventory and subsequent sales of this nutrient rich material. Depending on the consistency of these reject streams; positive displacement type discharge pumps would be suitable. These same level sensors could alarm at a certain defined level in order to initiate tanker type truck pickup of the contents. In addition, these sensors would also control the off on function of the discharge pumps. In a similar way, the automatic backwash feature associated with the sequential depth filters (elements 44, 52) in Subsystem 14 FIG. 1, could be tied into the same PLC to log both number of backwash events as well as time duration between events. This data could be used as a surrogate for either the overall condition of that specific depth filter assembly, or to indicate that something upstream has occurred such that downstream loading at the filters has changed and should be investigated. This same PLC could monitor the level of chemical at the chemical dosing unit for: the anti-scaling for the reverse osmosis element 72 (see FIG. 7), chemical injection if required at the dissolved aeration floatation (see FIG. 5) element 58, or the lamella clarifier unit element 26 FIG. 1.

In one embodiment anti-scaling chemical volume at the reverse osmosis, element 72 FIG. 1 can-be monitored with a subsequent signal for the need to replenish. The same PLC as referenced above can log the run hours of the system and indicate the time for scheduled maintenance as well by example, the time to chemically clean the reverse osmosis membranes. As a non-limiting example, the PLC can be programmed to start up and shut down the system in the correct order. Shutting down element 72 before previous unit process steps elements 44, 52, 58, and 68 FIG. 1 can cause equipment damage and create a mess in terms of unintended spills. In one embodiment system 10 components can be cleaned with an automated spray shower at certain predetermined intervals and especially at the beginning of shut down periods.

In one embodiment the PLC can be programmed and configured to log operating data remotely as well as auto dial for operator intervention as and when required.

As a non-limiting example system 10 FIG. 1 can, be used for pumping out existing lagoons and treating the waste stream that is discharged. In addition, this technology could be used to handle the cleaning of various operating tanks at municipal waste plants (POTW) prior to scheduled maintenance by effectively using the portable process as a bypass. In addition, it could be used to clean out fish hatchery facilities. This could also extend to lagoons at pulp and paper facilities and provide temporary process bypass to do maintenance at large septic systems associated with institutions.

As a non-limiting example pumping out of lagoons is required as scheduled maintenance and is done prior to removing solids accumulated at the bottom of the targeted lagoon(s) on an annual or biannual basis. System 10 FIG. 1 permits the pumping out of existing lagoons and the discharge of the cleaned water for use as irrigation, barn flush water, other OP process, or potentially for watering livestock. As the recovered water can be compliant with watershed discharge the lagoon can be emptied without having to create another lagoon to take the discharge from the first. This then allows for the concentration of the nutrients that are in each of the specific and progressive unit process steps. This material can then be applied in a targeted manner to specific fields either on or off the farm in a manner consistent with The Nutrient Land Management Act. In one embodiment system 10 FIG. 1 can, be used as a trailer scaled system capable of being moved in order to provide remediation to seasonal lagoon operations, or remediation cleanup of abandoned facilities, and the like.

As a non-limiting example in the case of industrial food processing plant plants which are processing organic material, much of the solids in the discharge stream can be extracted by elements including but not limiting to vibrating screen or other dewatering alternative located at the plant's discharge to a local sewer facility. This extracted material may be sold for animal feed. The value gained by the processing plant in selling the dewatered material is typically dependent on the volume of material produced, the quality of the material produced, the shipping distance required to take the material to the final location, as well as the number of other processing plants generating material that will ultimately be in competition if supply is greater than demand.

As a non-limiting example system 10 FIG. 1 can, be used to treat continuous waste streams as generated by food processing plants, breweries or other waste generating processes. In some cases, it may be necessary to install a surge tank at the start of the nutrient concentration process to level out variations in infeed flow rates associated with batch processes. In one embodiment unit process step element 26 FIG. 1 can have significant value when applied as conditioned infeed for different anaerobic digester processes, lagoon draining for maintenance purposes, industrial food processing waste streams or barn flush, and the like. As a non-limiting example, a surge component of system 10 FIG. 1 reduces the size of the downstream components for the maximum instantaneous flow rate(s) and supports the use of the most cost effective and properly sized nutrient process system for the waste stream in question.

In one embodiment system 10 can handle an incoming liquid waste stream contaminated with less than 50,000 ppm (parts per million) of solid material, excluding dissolved material. The dissolved solids in the filtrate in this stream may be up to 1.5%. The rest of the solids content is in suspended solids form. Total solids removal performed by the dewatering equipment such as a vibrating screen, or alternative drum screen and press varies depending on the influent characteristics and particle size distribution. Removal efficiencies can range up to 50% or higher for total suspended solids (TSS). Dewatered reject streams with up to 15 to 20% total solids (TSS) without the use of an additional screw press can be achieved. Use of an additional screw press to further dewater solids from unit process element 18 FIG. 1 can achieve 30+% TS (Total Solids). A large fraction of the P and N nutrients in the flow stream element 24 leaving the dewatering equipment remain with the filtrate (liquid stream). The remainder of the nutrients will have attached themselves and left with the dewatered solids.

As a non-limiting example there are different ways to perform the initial dewatering process. As referenced earlier, a vibrating screen fitted with a timer actuated spray shower for periodic wash down would be a typical piece of equipment. Any spray shower water would use recovered waste water with a TSS particulate size of <5 i.t. to avoid spray nozzle plugging as well as avoid additional waste water generation. This water could be taken from flow stream element 56 FIG. 1. There are many combinations of drum screens, inclined parabolic wedge wire type dewatering screens, as well as twin wire devices. In addition, there are number of different presses available. Selection is based upon performance, reliability and cost.

As a non-limiting example there are many different uses for the varying qualities of water (dependent upon the concentrations of nutrients and/or contaminants) generated from this process. The overall economics combine the capital and operating costs with the operational savings and are dependent upon an overall incoming waste water volumes and quality. Only by being able to clearly characterize each of the flow streams, as well as the technology required (and the corresponding capital and operational costs) can the capital cost be minimized, and the operational savings maximized. A key point to emphasize here is that the system economics is tied to the best treatment practices for each unit process as the flow cascades through these various unit process steps.

In one embodiment the system infeed material must be maintained at a temperature above 34° and below 115° F. for the nutrient concentration and water recovery system.

As mentioned above, the infeed material must not exceed 50,000 ppm of suspended solids material. If the concentration is greater than that, an incremental solids reduction unit process step would be required prior to feeding into the Nutrient Concentration and Water Recovery Process. Depending on the suspended solids loading greater than 50,000 ppm, additional solids removal strategies can be added. Selecting the most cost-effective option would be dependent on the infeed material flow rate and the suspended solids loading rate in excess of 50,000 ppm.

In one embodiment divert valves can be used before unit processes element(s) 26, 38, 58, and 68. These divert valves element 78 FIG. 1 would permit unscheduled maintenance in some cases while still being able to partially clean/remediate waste water. As initially sized for a periodic waste water flow of 240,000 to 280,000 gallons per day, certain unit process steps achieve/reduce the steady state continuous flow rates of @ 180 gpm by adding the necessary unit process modules in parallel. Therefore, a shutdown by one module does not shut down or take off line that functional unit process waste water treatment. Other divert or bypass valve systems would be added based on specific applications and installations. As proposed here, is not intended to be limiting.

As a non-limiting example, a desirable pH of the incoming material is in the range of 6.0 to 8.5 pH (without the addition of chemical injection to adjust pH to that range). More neutral pH conditions extend the equipment operating life, reduce EPA noncompliance issues, and potentially mitigate chemical usage either for neutralizing and/or flocculation additives.

In one embodiment the surge tank element 38 or designated lagoon can be used for waste stream cooling if installed after a thermophilic anaerobic digester to reduce the stream flow temperature to within the range stated above. This may be necessary as the system infeed material must be maintained at a temperature below 115° F.

As a non-limiting example one function of the combined unit process step identified as element 26 on FIG. 1 is the removal of suspended solids. As a non-limiting example this can be a two-stage unit process step. The reject concentrated suspended solids from each of various stages can be combined or separated. Dissolved solids are also removed in this step, primarily since some of the dissolved solids material is attached or agglomerated to the suspended solids which are removed by this process step.

The element 26 is both a fractionation/settling tank and a lamella clarifier. The fractionation tank and a lamella clarifier are co-located within the same tank.

In one embodiment element 26 of system 10 executes a two-stage unit process step. The first function is a settling chamber to drop out larger suspended solids. The second function in this unit process step is a high-efficiency clarifier intended to focus on removing the smaller suspended solids.

In one embodiment flow into the fractionation tank is designed for the peak flow condition which is by example once every 8 hours for a one-hour duration. When handling high volume but intermittent flows, System 10 is designed to achieve a slow infeed flow rate, typically referred to as the flux rate and expressed in terms gpm/per square foot of cross-sectional area (of the fractionation tank) in order to settle out suspended solids. Based on fluid dynamics, the slower the flow rate the smaller the particulate size removed. The greater the difference between the settling or downward flow rate of the particulate when compared to the flux rate of the flow stream across the fractionation tank, the more effective the particulate removal is and the smaller the particulate material size removed can be. All the above process parameters are evaluated in order to minimize or avoid all together the use of chemicals to assist in the precipitation of the suspended material within the flow stream at the lamella in element 26.

The rejects from element 26 are combined and discharged. In one embodiment there can be multiple destinations for this flow stream. The reject (thickened sludge) stream element 29 from this second unit process can be directed to several locations dependent upon the operating facility in which the nutrient concentrator system has been installed. If the nutrient concentration system has been installed after a digester, the rejects sludge stream can be redirected to the front end of the anaerobic digester, given it may be rich in volatile organic solids which have not been broken down by the first pass through the upstream anaerobic digester. If the material is found not to be rich in volatile organic solids, or if there is no upstream digester process, the material can be directed and combined with the rejects (FIG. 1—dewatered solids) from the vibrating screen or other dewatering device detailed as flow stream element 20 for potential onsite composting by others.

Given the relatively smaller volume of element 29 reject stream FIG. 1, it can be blended with the rejects, element 20 of the vibrating screen element 18 by example without an appreciable reduction in the percent solids of the dewatered rejects. This is important as maintaining a certain minimum percent solids target will avoid difficulties associated with a watery waste when handling, trucking, spreading, applying or disposing of the material.

As a non-limiting example, the volume of flow stream element 29 is dependent on the recovery performance of the unit process element 26 FIG. 1. Recovery is defined as the fraction of the material that flows out in flow stream element 30 compared to the infeed flow stream element 24. Recovery rates ranging from 75% to 98% are achievable with this technology and will greatly affect the flow rate of the rejects stream element 29.

As a non-limiting example, the targeted suspended solids level in the discharge, FIG. 1—flow stream element 30 of this unit process step can range from 2000 to 8000 ppm suspended solids from unit process element 26. As a non-limiting example this can be dependent on the particle size distribution in the incoming waste stream.

As a non-limiting example depending on the nature of the waste stream in question, that levels of suspended solids remaining in flow stream element 30 FIG. 1 may be below the 2000 to 8000 ppm stated above. Lower TSS levels for 1000 to 2000 ppm may be achieved. As a non-limiting example removal levels of this magnitude may be achieved with minimal or no flocculant or chemical dosing. The requirement for dosing can be confirmed on a case-by-case basis. By removing the need for costly chemical treatment, the ongoing operating costs and therefore the payback potential for the system is enhanced. Operator maintenance is also reduced if chemical injection is not required.

The overarching concept associated with nutrient concentration and water recovery patent continuation in part is based on maximizing the value of each of the components within the waste stream that has been generated by the barn flush of a dairy or other agricultural CAFO. This same concept also applies to the treating of waste streams generated within the food processing plant, or any other concentrated animal feed operations associated by nonlimiting example with hogs, chickens, fish farms or other organic waste disposal opportunity including but not limited to algae, kelp, or invasive weeds.

The second key concept associated with the nutrient concentration and water recovery patent addendum/continuation is based on the natural occurring tendency as confirmed by independent published research that primary nutrients; N P K (Nitrogen, Phosphorous, Potassium) are distributed in the organic suspended solids of by nonlimiting example dairy manure waste streams in a regular and repeatable format. Generally, nitrogen; N is mobile. It can be found in the waste stream in the dissolved liquid state, and in the solid-state adhering to certain suspended particle size organic material. When exposed to water and at normal atmospheric pressures it can volatize into ammonia gas. The phosphorus is much more stable and is found almost exclusively in the solid-state adhering to broad range of suspended particle size organic matter. The potassium: K is found generally in the dissolved liquid state only. Any incremental removal of potassium using mechanical filtration that does occur is based on either the liquid adhering to and removed with the solid's filtration step, or the liquid absorbed within the solid organic waste material that is mechanically extracted from the waste organic stream.

There are two important issues associated with maximizing the value of each of the components within the waste stream. The first is to convert the extracted components and modify as required to achieve the highest resale value for these products including but not limited to bio-stimulants, bio-solids, bio-fertilizers and animal bedding or compost.

The second important issue is to modify these waste stream components in order to minimize the negative but very real impact on the environment as well as minimizing the operational cost impact of managing these waste streams.

As the process embodied by this patent application includes a progressive series of filtration steps intended to extract solid material from a waste stream, the sequence and selection of extraction technologies for each of these progressive steps is critical.

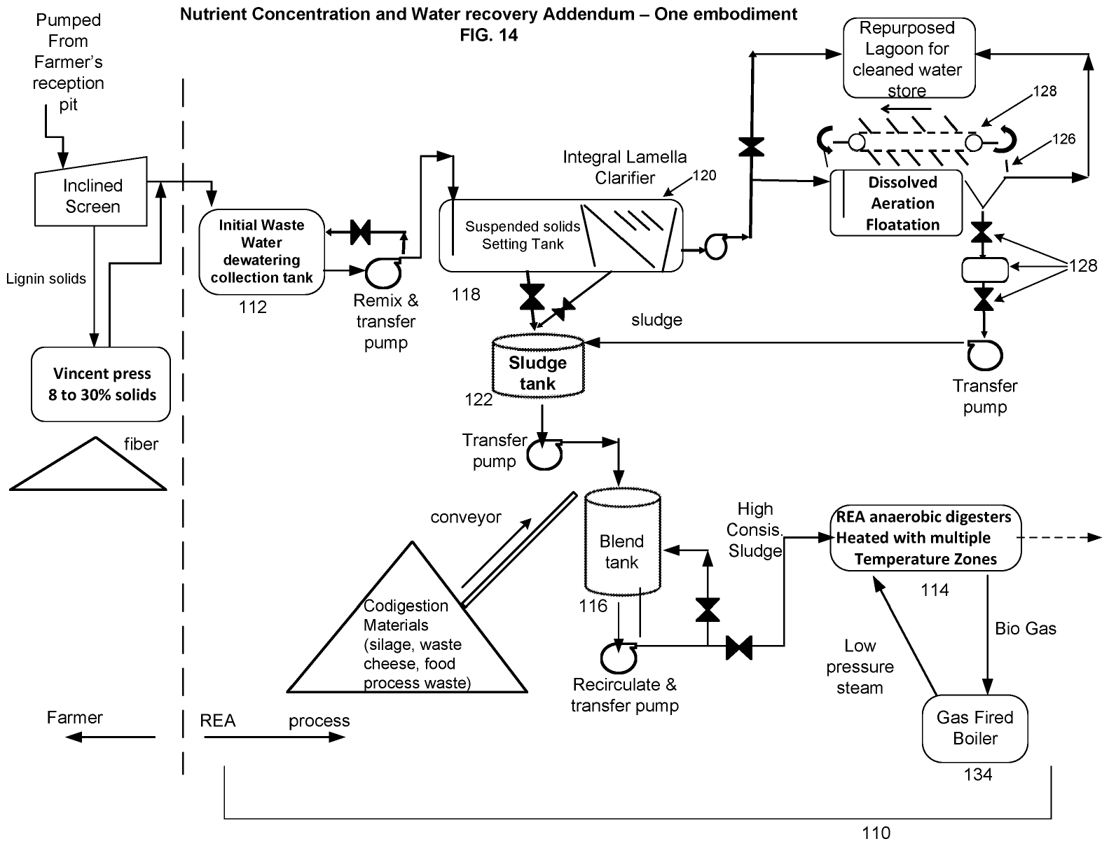

The first step in the process incorporates vibrating screen technologies element 206 FIG. 14. This step is targeted to remove all the solids/rigid lignin related materials such as straw and/or foreign materials from the waste stream. Amplitude of vibration, frequency of vibration and screen aperture size are all pertinent adjustable process variables used to extract the solid lignin material from the remaining waste stream components including semi-gelatinous lignin material and other organic suspended solids.

Removing this material at the beginning of the process, minimizes the potential for fouling finer and finer downstream filtration steps. It also minimizes the potential for accumulation of the lignin material within the downstream anaerobic digester process where it would plug resulting in operational shutdowns. As lignin is not broken down by the anaerobes in the digester it represents only an operational liability and no operational benefit to the biogas production process. If the lignin was extracted from the waste stream and diverted to the on-farm lagoon, it would require extensive maintenance to remove the material accumulation on an ongoing basis.

Rigid unmodified lignin can be used by the farmer as the animal bedding supplement. It can also be used for other on farm activities including but not limited to composting.

The second step in the process incorporates a sedimentation settling tank element 221 FIG. 14 with an adjustable cross-section flow stream which in turn adjusts the flow stream velocity in order to separate the heavy inorganic materials such as sand from the organic suspended solids in the waste stream.

Removing the sand material at the front of the process minimizes the abrasion and damage to pumps, piping and other downstream materials which is well known to occur when sand or other similar inorganic material is in suspension in a turbulent flow stream. Sand would also have high potential to settle within the very slow velocity zones of the anaerobic digester. If the extracted sand sludge stream was directed towards the lagoon, it would require extensive maintenance to remove that material accumulation on an ongoing basis.

Sand can also be used as a bedding supplement by the farmer or used as soil amender for soil drainage improvement or additives on the farm site.

The third step in the process incorporates a fabric filter element 227 and 230 FIG. 14 with a wide range of i.t. rated filtering mesh selections. It utilizes a constantly vibrating filter membrane to remove accumulated suspended organic material that it extracts from the waste stream. It can process incoming waste stream suspended levels of 1000 to 100000 ppm organic suspended solids and reject/discharge a sludge with up to 100,000 ppm of organic suspended solids without incremental dewatering. As there is no backwash function, but a constantly cleaning vibrating feature, the extracted suspended solids are not diluted by backwash water. This ensures maximum sludge consistency being fed into the downstream anaerobic digester thereby reducing the capital cost for the digesters. In addition, should this organic sludge be sold as a valuable bio-solid with primary N P K nutrient constituents, as well as micro-nutrients and microbiology, shipping distances are extended given the reduced water component of this extract stream.

The fourth step in the process incorporates disc filters elements 249 and 252 FIG. 14 which use compressed air rather than water to backwash accumulated extracted organic material that has accumulated on the surface of the filter surface(s). The suspended solids removed from the targeted organic waste stream are not diluted using backwash water. This ensures maximum sludge solids levels being fed into the downstream anaerobic digester thereby reducing the capital cost for the digesters. In addition, should this organic sludge be sold as a valuable bio-solid with primary N P K nutrient constituents, as well as micro-nutrients and microbiology, shipping distances are extended given the reduced water component of this extract stream.

The fifth step in the process incorporates in-tank suspended ultra-filter membrane elements 261 and 264 (FIG. 14) which utilize compressed air sparges to bubble up over the vertical outer suspended membrane surfaces within the suspension tank to remove any accumulated suspended solids from the surface(s) of these membranes. This ensures maximum sludge solids levels being fed into the downstream anaerobic digester thereby reducing the capital cost for the digesters. In addition, should this organic sludge be sold as a valuable bio-solid with primary N P K nutrient constituents, as well as micro-nutrients and microbiology, shipping distances are extended given the reduced water component of this extract stream.

The sixth step incorporates an optional reverse osmosis element 276 FIG. 14 to remove potentially increasing concentrations of dissolved chemicals from the recirculated barn flush water in the case where insufficient barn flush ultra-filtered filtrate water has not removed. By non-limiting example this recycle “bleed” stream could be used as bio-stimulant irrigation water or dilution water for the thicker bio-sludges-soil amenders. Without a “bleed” of the recirculated barn flush water, dissolved chemicals which are untouched by the mechanical filtration steps prior to the reverse osmosis step could accumulate to damaging or harmful levels over time.

Treating only a portion of the ultra-filtered barn flush water with reverse osmosis element 276 to control undesirable dissolved chemical accumulations within the recycled barn flush minimizes the volume of the dissolved chemical rich fluid to be processed and reduces capital and operating associated with reverse osmosis.

FIG. 14 element 203 defines the transfer pump installed at the reception pit where all dairy barn flush liquid and solid material drain to. By non-limiting example, the reception pit at the dairy could be substituted by the final waste collection pit at a food processing plant where final pH and suspended solids adjustments are made prior to pumping the waste material to a sanitary sewer system and/or a site-controlled lagoon.

Element 206 refers to the typical farmer installed inclined wedge wire stainless steel screen over which the barn flush liquid and solid material is pumped to separate the large solid material from the liquid material.

The above configuration is typical of most large CAFO (concentrated animal feed operations) including but not limited to dairy farms.

This inclined screen element 206, is a costly piece of installed equipment, that is difficult to modify such as in the case of a dairy if the manure characteristics within the barn flush stream change for any reason including but not limited to seasonal animal feed ration changes. This equipment requires extensive amounts of screen surface wash down water to avoid “blinding” the screen surface and subsequent loss in functionality as well as increased hydraulic load require larger downstream process equipment.

At many CAFO sites, the inclined screen has already been installed by the farmer/owner to reclaim and return the screen underflow (filtrate) to the farmer's solids settling lagoon to permit barn flush reuse. In some cases, at food processing plants a rotary drum screen is installed to extract suspended solids from the waste stream to minimize suspended solids and/or biological oxygen demand (BOD5) penalty fees prior to discharge to municipal sanitary sewer systems.

Practically speaking the inclined screen wedge wire openings range from 40 mesh to 60 mesh (400 i.t. to 2500. The symbol i.t. will be used hereafter as a short form for micron. The term filtrate will be used hereafter to refer to the filtered stream leaving the specific filter process step under review, and the sludge or solid component will refer to the suspended material component extracted/discharged/rejected from the waste stream.

One alternative to the inclined wedge wire screen, element 206 includes vibrating screens in various configurations. The vibrating screen has a smaller and more cost-effective footprint. It is less costly to purchase, install and operate than an inclined screen and much easier/less costly to expand throughput capacity. Importantly, adjustment of the screen element 206 opening by simple perforated screen changeout and/or adjustment of the vibrating frequencies and/or adjustment of the vibrating amplitude will permit a more accurate targeting and removal of the lignin material element 208 FIG. 14 within the barn flush waste water. By non-limiting example, the lignin within the solid component of the waste stream originates from the bedding or the feed for the dairy herd within the barns.

Current practices using the inclined screen element 206 FIG. 14 generally separate and extract element 208 comprised of not only the course and hard lignin-based straw material but also the semi-gelatinous partially broken-down/digested lignin material as well as the large volatile organic solids material component of the manure. These last 2 waste stream components; the more gelatinous partially broken-down lignin material as well as the large volatile organic solids material have more value if separated from the lignin material and directed downstream as element 215 rather than comingled in element 208 FIG. 14; the lignin solids extract stream.

Therefore, it is recommended to increase the wedge wire effective opening on the inclined screen element 206 if already installed by the farmer in order to specifically remove the solid lignin only but not the other two components: the more gelatinous partially broken-down lignin material and the large volatile organic solids material in the flushed waste stream.

If an inclined screen is not already installed or the existing unit cannot be modified as described above, a vibrating screen with the advantages detailed above can be installed in the position designated as element 206 FIG. 14 to perform this process function and with much greater process adjustability.

Then the sludge, element 208 FIG. 14 extracted by element 206 is then dewatered by the solids screw press element 209. Liquid extracted by this screw press, element 218 can then be added back into the downstream flow element 215 from the vibrating screen element 206.

By being more selective and extracting only the hard lignin-based straw material element 208 of FIG. 14 at this first separation phase element 206, the bedding properties of the lignin straw stacked at the accumulation pile, element 212 can be preserved for reuse as bedding or directed to composting since the material has been dewatered at a Vincent or equivalent dewatering press element 209 (often already installed) at the site by the owner.

Removing this material at the beginning of the process, minimizes the potential for fouling finer and finer downstream filtration steps. It also minimizes the potential for accumulation of the lignin material within the downstream anaerobic digester process where it would plug resulting in operational shutdowns. As lignin is not broken down by the anaerobes in the digester it only represents an operational liability and no operational benefit to the biogas production process. If the lignin was extracted from the waste stream and diverted to the on-farm lagoon, it would require extensive maintenance to remove the material accumulation on an ongoing basis.

This undigested lignin can be used by the farmer as the animal bedding supplement. It can also be used for other on farm activities including but not limited to composting.

Therefore, the constituents of flow element 215 and flow element 218 will have a reduced solids component given the extraction of the lignin-based material from the other suspended solids within these flow streams. The concentration or percent solids of these 2 flow streams flowing into the sand removal device element 221 will generally be less than or around 2% by weight in a conventional barn flush operation. Element 221 can be fed gravitationally and therefore avoid the requirement to accumulate flow streams element(s) 215,218 in an accumulation tank and pressurize with a pump (both not shown on FIG. 14). Element 221 will be used as a sedimentation settling tank or equivalent as opposed to a pressure fed hydro cyclone or costly centrifuge to remove the denser inorganic sand material element 225 from flow elements 218 and 215. Gravitational flow will minimize the potential erosion in downstream piping and equipment from the sand within the flow stream, element 215 and element 224.

Any sand within this flow stream, element 215 is damaging to the piping materials, pumps and any related process equipment. In the case of dairy operations utilizing barn flush, sand accumulates in the barn flush waters due by non-limiting example to airborne sand settling inside the semi-enclosed barns, or sand like material generated due to the erosion of the concrete flush alleys by the wear from the hooves of the dairy cattle or miscellaneous inorganics in the animal feed rations.

FIG. 14 element 221 is an in-line sand removal device. With the removal upstream of the stringy or hard lignin material, a sedimentation settling tank which drops the flow stream velocity to less than 0.2 feet/second can be used to continually extract and concentrate most sand (>0.25 mm) within this waste flow stream. A round tank with sloped or conical bottom, element 221 with an adjustable height central weir plate, can be used to adjust the effective cross sectional flow area and therefore flow stream velocity under the weir and above the bottom of the bottom of the tank to the best effective velocity to drop out the heavier specific gravity sand entrained in flow element (s) 215,218. The sand will accumulate in the bottom of element 221 and an auger or positive displacement pump element 222 discharges the extracted sand element 225 to an accumulation pile element 226. The separated sand can be used for incremental cow bedding needs or for blending with bio-solids to improve the pre-digester bio-solids element 234 attributes as a soil amender.

The operational principle of a sediment settling separation device is based upon Stoke's law of hydraulics. The targeted inorganics sand particles will generally have a specific density significantly greater than that of the suspended organic particles. By dropping the flow stream operating velocity to below 0.33 ft/second, the inorganics are dropped out of suspension and are removed by an auger or positive displacement pump element 222 FIG. 14 operated on a timed cycle.

Removing the sand material at the front of the process minimizes the abrasion and damage to pumps, piping and other downstream materials which is well known to occur when sand is in suspension in a turbulent flow stream. Sand would also have high potential to settle within the very slow velocity zones of the anaerobic digester. If the extracted sand waste stream is directed towards the lagoon, it would require extensive maintenance to remove that material accumulation on an ongoing basis.

As the hydrocyclone requires a pressurized feed to separate material of a different specific densities, an accumulation tank and feed pump will be required. By substituting a non-pressurized sedimentation settling tank element 221, an additional pump can be avoided. In addition, given the inclined screen element 206 FIG. 14 or vibrating screen can be gravity fed and as the 1st stage filtration item 227 can also be gravity fed, it would be simpler and less costly process configuration to pump up to the vibrating screen element 206 only and gravity flow downwards away after that.

If the upstream equipment elements 206 and 221 of FIG. 14 have been elevated such that filtrate flow out of element 206 gravitationally cascades down into element 221, then the gravitational flow out of element 221 can also gravitationally flow and feed the 1st stage of organic solids filtration element 227 or additional unit element 230 required for throughput capacity. This will require the discharge from element 206 is higher than the infeed into element 221 and the discharge from element 221 is higher than the inlet into the top of the Vincent Fabric Filter or equivalent element.14. Collection tanks with instrumentation and transfer pumps and their inherent capital and operating and erosion related maintenance costs would be avoided.

The following detailed description and advantages are expanded below.

Organic waste streams from Concentrated Animal Feed Operations (CAFO) or Food Processing Plants have significant nutrient potential if extracted and used as crop bio fertilizers and/or bio-stimulants and bio-solid soil amenders. These terms are defined and used within the agricultural, nursery and green house industries.

Much available mainstream test data has confirmed the importance of N P K for agricultural plant growth. The primary nutrients of interest in the application of the Nutrient Concentration and Water Recovery Technology addendum are, nitrogen, phosphorous and potassium N P K as well as soil mechanics enhancing microbes). Independent testing has confirmed that the majority of phosphorous is retained with the suspended organic solids within the waste stream, whereas much of the potassium remains in the liquid component of the waste stream as a dissolved component. Nitrogen on the other hand is somewhat dynamic and exists in the solid organic material as well as the liquid component and volatilizes to become a nitrogen gas.

After the removal of suspended lignin material by element 206 FIG. 14 and inorganic sand by element 221 FIG. 14, key sequential filtration steps are installed in a specific descending particulate distribution size removal sequence to remove targeted N P K. The performance of these selected filtration steps and in the sequential configuration defined within this patent addendum will have a profound impact on not only the capital costs of the Nutrient Concentration and Water Recovery Process, but also on the operating cost and the number of economically valuable byproducts generated.

These filtration steps are designed to incorporate the relationship between suspended solids particle size distribution of organic waste from, CAFO sites associated with by non-limiting example dairy, hog, chicken and fish operations as well as food processing waste streams and concentrations of the primary nutrients N, P, K. This relationship between different particle size distribution ranges, generally expressed in i.t. size, and the different concentrations by weight of these primary nutrients is still under development for different manure types.

As the separation of N, P, K from the waste streams is impacted by the source of the organic waste as stated above, but also by the desired weight ratios of N, P, K for the targeted reformulated biofertilizer/bio-stimulant sought by the end user, the sequential i.t. range of each filtration step will change to accommodate these factors. The filter stages elements 227 and 230,249 and 252,261 and 264 and possibly 276 in the pre-digester process but also in the filtration steps elements 298,307 and 305, 334 and 337, 346 and 349 in the post digester process FIG. 14 may all require adjustment in order to accommodate by these factors.

Element 227 of FIG. 14 is the first conventional filtration step in the process after lignin and inorganics extraction and uses a fine fabric filter capable of continually self-cleaning. By non-limiting example the Vincent Corporation makes a fabric filter, FIG. 14 element 227 that vibrates continually during operation such that the filtering fabric membrane is continually cleaned. This is important for several reasons. The unit does not have to be taken off-line to be cleaned and therefore a redundant unit at significant capital cost does not have to be installed. In addition, Vincent Corporation offers several different i.t. rated fabric membranes, from greater than 100μ to i.t. values in the teens. The objective is not only to remove the larger volatile organic suspended solids, but to do so with as little entrained water as possible to maximize the percent solids by weight of the sludge extracted as element 334 FIG. 14. This is important to generate an 8% to 12% solids by weight waste sludge stream to prepare prior to pumping into an anaerobic digester. Anaerobic digesters are enclosed vessels intended to capture the methane gas generated during the volatile organic solid's digestion process. Excess water put into the digester displaces volatile organic solids thereby reducing the methane gas yield or increases the sizing of the digester vessels and therefor the capital and operating costs. Field tests utilizing the Vincent fabric filter element 227, FIG. 14 were able to process barn flush infeed manure water ranging from 1.1% to 5% solids and generate a sludge percent of solids up to 8% to 13%. Different fabric filter i.t. rated screens were used successfully during these field tests.

A source of nitrogen gas of high quality can be generated using fully established and industry proven gas membrane technology and filtering compressed air. This system is detailed elsewhere in this patent writeup.

The filtrate element 237 generated by fabric filter element 227 must be directed into a transfer tank element 240 FIG. 14 as the next downstream filtration step in this embodiment must have a pressurized feed. This is an enclosed tank intended to hold the filtrate. As much of the finer organic suspended solids material with its entrained nitrogen component is still in this stream, effort must be made to minimize the volatilizing (off gassing) of nitrogen from this filtrate stream.

Dalton's law of partial pressures is applied here. As a component of the gas pressure above the liquid in the transfer tank element 240 will now be nitrogen gas, its presence acts as a resistive buffer to what would otherwise be the further volatizing or off gassing of nitrogen from the liquid surface within the tank.

This would occur if the tank was not covered with a low-pressure cover. An open tank would be exposed to airflow associated with ambient conditions around the tank including low pressure surface winds such that the nitrogen gas would be constantly swept away above the liquid surface. This in turn would drop the partial pressure component associated with the nitrogen gas above the tank liquid or sludge surface and would draw more nitrogen from the liquid or sludge phase into the air above the liquid surface. This would reduce the nitrogen content of the liquid/sludge in tank, element 240 FIG. 14.

A transfer pump element 243 is controlled by level control instruments element 242 FIG. 14 installed in the transfer tank element 240. This pump pressurizes and transfers filtrate element 246 into the 2nd stage filtration step, element 249 and 252 FIG. 14. By nonlimiting example, an Azud type pressure disk filter (element 249) is used to remove much of the remaining volatile organic suspended solids. Test results while utilizing multiple different i.t. rated disk filter elements, were able to confirm reduction of the residual volatile organic suspended solids down to levels near or below 1000 mg/L (1000 parts per million) in the filtrate element 258 FIG. 14 discharge stream. Disc filtration size ratings of 80 i.t. to 5 i.t. were used during those field tests.

This 2nd stage filter, element 249 and 252 FIG. 14 must be installed with multiple units in parallel operation to permit taking some/or one of the units out of operation in order that they can be back washed for cleaning. Based upon exceeding a predetermined differential pressure across these pressurized disk filter units, a backwash cycle is triggered. This climb in differential pressure across the filter disc(s) indicates that the filter surface is slowly blinding off due to accumulation of organic suspended solids on the filter surface as these suspended solids are removed from the waste stream feed element 246 FIG. 14.

Based upon the specific characteristics of the waste stream being treated, anywhere from 60 to 90+% of the organic suspended solids have been removed by the time that the waste stream element 246 has been processed by filter element 249 and 252 and is discharged as filtrate element 258.

As mentioned previously at a certain predefined differential pressure across this disc filter element 249 and 252 FIG. 14, a backwash function is actuated. In order to minimize the dilution of the removed organic waste accumulated on the disc surface, compressed air rather than backwash water is utilized. In this way the periodic removal of accumulated filtered organic suspended solids is removed at the highest percent solids possible. This is critical in order to sustain and maintain the highest percent solids sludge conditions of sludge stream element 255 FIG. 14 to be fed to the anaerobic digester. In addition, by minimizing this reject waste stream volume by using this compressed air the cost of handling this concentrated waste stream element 255 is reduced.

Specifically, the suspended solids as defined in element 255 would typically range between 1.0 to 5% TSS and would be directed to a pre-anaerobic digester blend tank where the extracted suspended solids stream(s) elements 234,255 and 267 FIG. 14 are co-mingled and then conditioned based on pH, homogeneity of particle size, material homogeneity, consistency/or percent solids and temperature prior to transfer/insertion into a thermophilic anaerobic digester (detailed in a separate author owned patent). By minimizing the incremental addition of backwash water, the cost of these conditioning steps and the size of the equipment is minimized thereby enhancing profitability and therefore industry acceptance.

The filtrate element 258 FIG. 14 as defined above has suspended organic solids levels @1000 ppm (parts per million) based upon field tests.

By nonlimiting example, element 261 and 264, FIG. 14 are ultrafiltration membrane assemblies capable of filtering suspended solids down to 0.5 to 0.1 i.t. rating and are Flex disc II membranes manufactured by Avant or equivalent. As in the case of the 1st stage filtration, representative element 227 and the 2nd stage filtration, element 249, the extracted suspended solids removed by these membranes does not require incremental backwash water flows which would otherwise decrease the concentration of extracted solids in this waste stream. Without additional backwash flush water, the flow rate of element 267 is minimized as are the sludge volumes to be handled. As referenced above, concentrated waste sludge streams with a minimal water component can be processed either in downstream anaerobic digestion or used as a solids soil amender/bio-solid in a cost-effective manner due to the higher concentration of solids levels.

In one embodiment, the Flex disc II membranes, FIG. 14 element 261 and 264, are cleaned with an air sparger to continually sweep the vertical outer surfaces of the suspended membranes within the tank filled with the waste stream element 258 FIG. 14 coming as filtrate from the 2nd stage filter element 249 and removes the accumulated suspended solids. By doing this the sludge material is concentrated over time and can be removed from the waste filtrate stream, element 258. Based upon the light suspended solids content within flow stream element 258, the continual air sparer cleaning may only need to be periodically augmented with chemical cleaning which would require that an additional ultrafilter filter module element 264 be installed in parallel operation to permit taking a fouled unit offline as required if chemical cleaning is necessary.

By utilizing the pressurized feed pump, element 243 of FIG. 14, the flow stream element 246 can be fed into the second stage pre-digester filtration step element 249 and 252. By non-limiting example, field tested Azud disc filters rated down to 30 to 5 micron rating are utilized to produce the filtered waste stream element 258. Residual pipeline pressure transfers flow stream, element 258 up into this elevated 3rd stage assembly element 261 and 264 including the processing tank(s) and the immersed vertically suspended Fluidics II ultrafilter membranes or equivalent. The bottom of this tank would have a distribution network of air headers that would act as spargers and bubble compressed air upwards through the liquid element 258 FIG. 14 in the tank assembly and scour the vertical surfaces of the membranes. The filtrate, element 270, generated by the ultra-filter membranes would then be directed to a common discharge manifold which would ultimately discharge from the tank and flow into an existing site lagoon, element 272 or transferred for optional processing into the reverse osmosis feed pump; element 243 and then on to the reverse osmosis skid, element 276 FIG. 14.

The use of this 4th stage of filtration: reverse osmosis element 276 FIG. 14 would not always be used. It is optional. In many cases this level of molecular filtration would not be required.

The filtrate from the 3rd stage filtration, element 270 will have up to 90 to 99% of all organic suspended solids removed.

With this level of suspended solids removed, a corresponding level of organic solids and volatile organic solids has also been removed. The following benefits are achieved in the pre-digester sequential filtration process.

The amount of off gassing from the lagoon to which the filtrate, element 270 is transferred after the 3rd stage filtration element 261 and 264, would be radically reduced with the utilization of this technology. Without the source of organic material within the filtrate, the suspended organic material within element 270 that is directed to the lagoon element 272 would not support any significant aerobic digestion and therefore the conversion of organics to organic methane within the lagoon would be reaching non-measurable amounts. Greenhouse gas emissions would be measurably reduced, thereby reducing the potential of EPA infractions.

With insufficient organic solids in this filtered stream element 270 FIG. 14 sent to the lagoon, aerobic digestion would not be biologically supported. Therefore, the intermediate products of aerobic digestion such as volatile fatty acids would not present in significant amounts if the lagoon contents element 270 was used as a liquid bi-stimulant/bio-fertilizer. It is the volatile fatty acids that stick to and damage new crop growth when applied throughout the crop growing season as a liquid bio-fertilizer.

In addition, the major reduction in suspended organic solids also significantly constrains the BOD5 (biological oxygen demand) potential of this filtered waste stream, element 270 and therefore reduces the potential for ground water contamination and subsequent EPA infractions.

The lack of suspended organic solids in filtrate element 270, would no longer require the current farming use of powered floating lagoon aerators to minimize organic solids accumulation in the lagoon.

Most of the nitrogen has been concentrated in the extracted sludge at the various pre-digester filtration steps. This would reduce the ammonia in flow element 270 FIG. 14 sent to the lagoon and therefore reduce lagoon odors.

If the filtrate, element 270, FIG. 14 is reused for barn flush, the major reduction in phosphorous in this recycled filtrate lagoon water would reduce the slime growth in the barn alleys and subsequently reduce livestock slipping injuries.

Use of filtrate, element 270 as a barn flush liquid source in a recycled approach would reduce the amount of fresh water makeup, given the highly filtered level of this stream.

Aquifer draw down and well pumping costs would correspondingly be reduced.

Consistent with this situation, and due to the removal of inorganic solids at element 225 FIG. 14 such as sand and the removal of virtually all the suspended solids through the sequential filtration steps listed above, settling of organic or inorganic suspended solids in the lagoon would almost disappear. Therefore, maintenance associated with accumulation of solids within the lagoon would be minimized.

The filtrate, element 270 FIG. 14 will now also have incremental dollar value. Apart from being able to be used in a recycle mode for dairy barn flush, the removal of virtually all the organic suspended solids have changed the nutrient composition of this flow stream.

Based upon independent testing and analysis, the high removal levels of suspended solids from flow streams, elements 224,237,246 and 258 will ensure that virtually all phosphorous is removed and concentrated in sludge streams elements 234,255, and 267.

According to published data, the 3 filtration stages, elements 227 and 230, 249 and 252, 261 and 264 with the final stage filtration screen i.t. rating of 1.0 to 0.5 i.t. will remove up to @97 to 99% of the phosphorous initially in the waste stream element 224.

Based upon the high-level of suspended solids removal to this point in the process, much of the phosphorus (P) is no longer within the liquid filtrate, element 2700 FIG. 14 of the waste stream. This was stated earlier and has been independently validated. With virtually all the suspended solids removed from flow element 270, phosphorous (P) levels will be down at low single digit percentage values. This has multiple advantages. Should the filtrate, element 270 be directed to the lagoon, it can now be land applied for irrigation purposes and with some level of nutrient application included. Previously, only limited volumes of this liquid stream could be applied to the lands associated with the site, based upon the fact that the slow uptake of phosphorus from this liquid stream to the site crops/vegetation would increase the probability that a Nutrient Land Management Act violation associated with overloading phosphorus would occur. Now however, given the marginal nutrient content of phosphorous remaining within this filtrate element 270, and with desirable nitrogen content remaining as well as potassium, it's product dollar value could still financially support trucking distances away from the site. The add back of nutrients from waste sludge streams, elements 234,255, and 267 in a precise manner into the Tea Blend Tank element 257 and therefore into flow element 260 FIG. 14 as a desired irrigation/nutrient bio-fertilizer unique and repeatable formulation would enhance its market value. Note flow resettle able flow totalizers element 223 facilitate these repeatable custom formulations.

As the stream, element 270 FIG. 14 which can be sent to the lagoon element 272 or to the Tea Blend tank element 257 can be enhanced with add back nutrients and given its low phosphorous content, this stream still has multiple local uses such as land and crop irrigation. Without add back nutrients, the reuse of this liquid, flow element 270 would include being pumped from the lagoon storage element 272 FIG. 14 for repeated barn flushing or used for on farm irrigation water. With minimal phosphorous retaining organic solids content, ground water contamination potential and Nutrient Land Management Act violations are minimized. In addition, the same reduced organic content will not support either additional bacterial growth in this filtrate stream or algae growth in the dairy lanes of the barns. Slime accumulation in these locations would otherwise present a serious slip hazard for the dairy herd. As part of that reuse strategy, the reduced organics also simplify and reduce the cost of using the existing onsite lagoons without annual sludge removal maintenance costs or aerobic digestion off gassing.

Based upon the selected end-use for filtrate element 270, the fertilizer/nutrient composition of this stream can be modified. By carefully metering back some of the extracted sludge material as defined in waste sludge streams element 234, element 255 and element 267, the phosphorus and nitrogen can be increased. As stated earlier the dissolved potassium component would not have materially changed due to the extraction of the suspended solids. Potassium is in a dissolved state in the barn flush water and is largely not removed during the filtration process(s) unlike phosphorous and nitrogen. It is important to point out that potassium as a fertilizer/nutrient is generally not the constituent that represents a Nutrient Land Management Act violation component. Use of this enhanced filtrate can displace purchased fertilizers when applied as both irrigation and fertilizer to the site croplands. In addition, its enhanced constituents if combined with the extracted sludges; and with their included higher N P K levels from the sequential filtration steps add to its value and therefore support additional trucking distances to off-site locations, yielding improved revenues. Alternatively, the nutrient constituents within sludge streams element 234, element 255 and element 267 of FIG. 14, can be trucked longer distances in a concentrated form and then diluted with water at the final crop destination to then be applied through existing irrigation delivery systems.

All process configurations associated with bio-stimulant formulation(s) through nutrient add back have not been fully shown in FIG. 14 to minimize confusion in depicting the many blending options possible to more accurately meet end user requirements.

Bio-stimulant variations are based on the many nutrient recipes which in turn combine many formulations which include organic based N P K fertilizer constituents. These components are not considered as chemically based fertilizers when compared to traditional mined fertilizers. They do however include the micro-organisms which address and restore soil mechanics including but not limited to water retention of the soil, soil porosity, microbes to assist in nutrient uptake of the targeted plants and plant disease repair/protect properties.

There are three primary extracted flow/sludge streams; elements 234,255 and 267 in the pre-digester portion of the Nutrient Concentration and Water Recovery Addendum if the optional Reverse Osmosis is not counted.

Element 227 is the first and most coarse filtration stage and removes the largest size suspended solids particulate. As stated above, this sludge, flow element 234 is often the most concentrated from a TSS standpoint and that is often dependent on dairy herd animal type, dairy rations as well as barn flush frequency. Based upon independent technical publications and scientific research, when testing rated membranes ranging from 100 i.t. to sub-micron values, these membranes can achieve several desirable N P K composition percentages on a reproducible basis. These N P K percentages can range in one embodiment from low single digit to higher % N P K constituents by weight. By non-limiting example, the Vincent Corporation's Fabric Filter or equivalent with interchangeable membranes ranging from 100 i.t to less than 20 i.t can be used to function as element 227 of FIG. 14. The concentrated sludge stream produced, element 234 FIG. 14 can be altered based on specific membrane i.t. ratings selected to deliver a nutrient N P K constituent composition ranging from low to higher percentages by weight or can be transferred to the anaerobic digester blend tank for anaerobic digester processing. If the intended purpose is anaerobic digester feed, throughput capacity and ease of operation will define rated membrane(s) i.t. selection.

The details of how element 234 by one embodiment can be added back as a further source of N P K in to the final filtrate stream element 270 to enhance or adjust the final N P K formulation, or the converse where element 70 FIG. 14 can be added back into extracted sludge stream element 234 has been discussed above in a nonlimiting case.

This approach would also apply to sludge streams, elements 255 and 267 in mixing with filtrate stream element 270 or the converse as detailed above. There are multiple embodiments of this blending approach to formulate many bio-sludges and/or bio-fertilizer recipes not detailed within this patent application.

Alternatively, element 234 can be pumped to the Tea Blend Tank element 257 for pathogen kill and sold directly as a bio-solid/bio-stimulant. It should be stated that specific membrane selection(s) are needed to achieve desired N, P, K targeted values for bio-stimulant/fertilizer for specific end users.

Sludge, element 234 is sheared to reduce and homogenize particle size by pump element 233 FIG. 14 and transferred to the Tea Blend Tank, element 257. Level instrumentation element 242 on Tea Blend Tank and resettable flow totalizer, element 223 can repeatedly meter in to Tea Blend tank, element 257 the correct amount of sludge, element 234 with its fertilizer constituents N P K and combined with flow element 270 in one embodiment to adjust to other P, N, K formulations. Further P, N, K adjustments can be made by combining with or by substituting sludge flow element 255. Discharge pump, element 243 on the Tea Blend tank is used to further shear and reduce particle size of the add-back ingredients in flow element 260 FIG. 14 to make them compatible with customers' drip irrigation equipment.

By non-limiting example, the progressive filtration steps before the anaerobic digestion process can be selected and installed to adjust the N, P, K percentages of the bio-stimulant/fertilizer as well as the volatile organic content to maximize biogas generation in the anaerobic digester process.

This same flow, element 260 can be pasteurized within the Tea Blend Tank, element 257 to kill pathogens to comply with OMRI status. The retained amount of volatile fatty acids within flow element 260 is dependent on the amount of TSS remaining in this flow element 260. This in turn is dependent on the number of progressive filtration stages as well as the i.t. rating of these filtration membranes and if filtered and extracted sludge streams, elements 234,255, (and possibly element 267) in various combinations have been added back into the Tea Blend Tank, element 257. A significant removal of TSS would leave the filtrate (the filtered stream leaving the process) with reduced TSS. As volatile fatty acids are intermediate products in the anaerobic or aerobic digestion process any significant reduction in the volatile organic solids would reduce the potential for aerobic or anaerobic digestion thereby reducing the presence of volatile fatty acids and the associated “burning” of new bud foliage when applied to newly sprouted crops as a foliar. Therefore, the filtration process can also be adjusted to accommodate the time of the season that this bio-stimulant is applied to the targeted crop(s).

Sludge, element 255 FIG. 14 generated by the second pre-digester filtration stage, element 249 can be transferred to the anaerobic digester blend tank, or to the Tea Blend Tank, element 257 as was the case for sludge, element 234 FIG. 14. This sludge stream is generally less concentrated from a TSS (by weight) basis than extracted sludge element 234. Particle size is determined by the Azud or equivalent disc filters in this second pre-digester stage. Field tests incorporated 100 i.t. down to 5 i.t. filter elements. As stated earlier, the concentration of TSS is between 1% to 6% by weight. Sludge, element 255 is sheared by pump, element 243 to reduce particle size and transferred to the Tea Blend Tank, element 257 FIG. 14 or directed to the anaerobic digester blend tank for conditioning prior to anaerobic digestion.

Level instrumentation element 242 FIG. 14 on Tea Blend Tank and resettable flow totalizer, element 223 can repeatedly meter in to Tea Blend tank, element 257 the correct amount of sludge, element 255.

Given the finer filtration membranes of element 249 when compared to the larger i.t. filter membranes of element 227, most of the remaining bio-stimulant/fertilizer constituents within filtrate element 258 in suspended solids form are removed. Sludge element 255 is predominately N and P, as K is dissolved in the liquid constituent of flow stream, element 246 and is therefore not mechanically filtered out and remains within filtrate stream 258.

Discharge pump, element 259 FIG. 14 on the Tea Blend tank is used to further shear and reduce particle size of the add-back ingredients to make them compatible with customers' drip irrigation to avoid plugging nozzles. Add back of sludge streams elements 234,255 and to a lesser extent 267 must be carefully metered given their elevated P and N nutrient constituent levels. These sludge streams can then be blended with the filtrate element 270 of the third stage pre-digester filtration step element 261 and 264, which is rich in K, to achieve custom nutrient blends for specific crops thereby driving up the market value.

Filtrate element 270 FIG. 14 from the third stage pre-digester filtration step, has had up to 95 to 99% of TSS removed. It does have micro-nutrients and higher levels of Potassium such that if it was blended in the Tea Blend Tank, a balanced bio-stimulant/fertilizer tea would be generated.

In some cases, a live steam line could be used in Tea Blend Tank to pasteurize the contents to kill pathogens and obtain OMRI status making it a valuable by-product. Recipes could be formulated and consistently reproduced to meet specific crop growers' demands. Higher yields and OMRI certified fertilizers compatible with organic farming would increase demand and pricing.

The use of the optional 4th stage filtration, reverse osmosis element 276 FIG. 14 which would involve reverse osmosis membranes is not always required. As chemical addition on an intermittent basis for periodic membrane cleaning is required and the addition of an anti-sealant on a more continuous basis to mitigate the rate of fouling of the R 0 membranes, the process complexity increases. In addition, there needs to be the input of incremental energy to overcome the osmotic pressure in order to feed the RO skid, element 276 with the ultrafilter filtrate, element 270. Apart from the capital cost of the equipment there are incremental operating costs associated with energy, chemicals and operator intervention.

Generally, any reverse osmosis equipment installed would be sized for a partial flow rate associated with flow stream element 270 in order to mitigate the costs referenced directly above. Treating less than the full flow stream, element 270 will reduce the incremental capital, operating, energy and labor costs associated with element 276, the reverse osmosis.

By example, any accumulation such as dissolved sodium in barn flush water due to recycling this cleaned barn flush water could be addressed by treating only a portion of flow stream element 270. The reverse osmosis can extract up to 90 to 95 to 98% of the targeted molecular material; by nonlimiting example NaCl. If a portion of the filtrate, element 279 is treated with reverse osmosis treatment then the concentrations of the targeted molecular material, by non-limiting example sodium will be reduced to lower concentrations and then can be blended with non-reverse osmosis treated liquids to bring the combined overall weighted average flow stream concentration of sodium back into the desired concentration. This partial treatment of the filtrate element 270 FIG. 14 is a cost effective alternative when compared to installing and operating reverse osmosis equipment capable of treating the entire filtrate stream, element 270 FIG. 14.

Based upon field test data, filtration steps up to and including filtration stage 3, element 261 FIG. 14 reduce the suspended solids from less than 2% by weight down below 0.1% by weight in the filtrate stream element 70. Based upon mass balance calculations and laboratory testing and based upon a conservative 96+% total suspended solids (TSS) extraction across these filtration steps, extracted sludge as represented by flow elements 234, 255 and 267 represents 6 times concentration of the sludge stream which contains 96 to 99% of the total suspended solids by weight. This material can be directed to either the thermophilic anaerobic digester process or remixed and added back as N and P into the filtrate stream element 270 for enhanced nutrient marketability. Therefore, conservatively speaking, ⅙ of the overall flow weight (volume) coming from the barn flush system will need to be processed when leaving the anaerobic digester process. Clearly that will dramatically reduce the size of the process equipment for anaerobic digesting as well as the post digester processing equipment.

By increasing the organic solids and therefore the volatile suspended solids and reducing the amount of water entrained with the solids, additional space is available to accommodate more co-digestion materials in the anaerobic digester(s). As published data confirms that dairy manure provides a very low biogas generating potential, any other co-digestion additive would enhance the volume of biogas created. This would improve project economics and reduce such materials from accumulating in limited landfill sites.

The sludges, elements 234,255,267 or portions of these are first transferred into and conditioned in the digester blend tank. This sludge material is then combined with co-digestion materials that are readily available and cellulosic in nature in order to achieve desired carbon to nitrogen ratios as feed into the anaerobic digester(s). Reference author's separate and awarded anaerobic digester patent.

After processing by the anaerobic digesters, sludge and liquid material forced out of the digester's as element 289 FIG. 14 by the introduction of new material fed into the digesters at the front, the exiting digestate material is collected in the collection tank, element 292 FIG. 14. Equipment sizing is radically reduced at this point in the post digester process because of the concentration of the entrained TSS within the original flow stream, element 224 as detailed above. As discussed in paragraph 242, Therefore, conservatively speaking, ⅙ of the overall flow weight (volume) coming from the barn flush system will need to be processed when leaving the anaerobic digester process. Clearly that will dramatically reduce the size of the process equipment for anaerobic digesting as well as the post digester processing equipment.

A forwarding pump, element 243 FIG. 14 is activated to transfer the digestate element 297 from the digester discharge collection tank, element 292 to an elevated dewatering screw press. element 298, controlled by level control instrumentation, element 242 in tank element 292.

A centralized air compressor system is installed but not shown in FIG. 14 to provide compressed air for the air scouring or backwash assist of filter surface(s) including but not limited to elements 249,252, 261, 264, 334, 337 and 346 and 337 as well as compressed air for remotely activated process control valves. This air compressor also feeds the nitrogen membrane generator system.

A central nitrogen generator, not shown in FIG. 14 but operated as a gas (nitrogen) membrane filter supplied with compressed air from the central utility air compressor system (also not shown for process clarity) in FIG. 14 is installed to produce and inject N2 gas over the surface of the digestate in by non-limiting example the tea blend, digestate collection, dewatered storage tote and mixing tanks, elements 257, 292, 301, 316, 325, 344, 355 and 373 of FIG. 14 to minimize volatizing of the desirable Nitrogen from the sludge and/or organic tea bio-stimulant while also cooling it. This minimization of nitrogen vitalization is based imposing a nitrogen gas blanket over the surface of the sludge or liquid where the highest concentrations of nitrogen are to be found. As defined within Dalton's Law of partial pressures, a nitrogen gas blanket above the sludge or liquid acts as a retardant to the volatization of more nitrogen leaving the nitrogen containing sludges and/or liquids.

This screw press is the first filtration step in the post digester process. A portion element 286 of the digestate element 297 discharged from digestate collection tank element 292 FIG. 14 is used to inoculate the next batch of digester infeed material within the digester blend tank prior to transfer into the digester(s). This flow stream, element 286, is part of the mixture of new anaerobic digester feed material in the digester blend tank and then added to the feed material collected in and comingled and conditioned for the digester (s).

The digestate is dewatered at screw press element 298. The dewatered digestate, element 302 is collected below in sealable transfer tanks, element 301 with nitrogen gas pumped into the free space above the sludge to maintain the maximum nitrogen content of this organic bio-solid. It's nutrient value as well as the mechanical soil improving properties of this bio-soil amender including but not limited to ground porosity, soil aggregation, water holding capacity of the soil as well as a source of micro-nutrients including but not limited to B Boron, Cl chlorine, Cu coppered iron, Zn zinc, and Ni nickel are all high, thereby increasing the bi-product valuation of this organic certified bi-product. These attributes are present and have been tested and certified as a Class A bio-solid with virtually non-detectable pathogen levels when compared to a Class B bio-solid. These attributes make the extracted sludge material a Class A bio-solid compatible with OMRI organic farming.

Element 303 FIG. 14 has been dewatered to approximately 30% solids. It can be packaged and sold as a soil amending bio-solid with roughly equal parts N, P, K making it a very useful plant bio-fertilizer as well as a desirable soil amender. It can also be used as an additive and diluted with the dilute filtrate(s) generated downstream in the process by the progressively finer filtration steps.

Filtrate, element 304 from the screw press, then cascades gravitationally down into the second post digester filtration step, element 307 and 305. This is a much smaller capacity and less costly fabric filter than the unit element 227 described in detail in the pre-digester process area. By nonlimiting example, for a 3000 head dairy farm, if there are up to 11 anaerobic digesters discharging to the post digester system, then the post digester system must be sized for approximately 20 to 40 gallons per minute continuous feed.

Vincent Corporation also makes a fabric filter element 307 and 305 that vibrates continually during operation such that the filtering fabric membrane is continually cleaned of any surface extracted suspended solid accumulation. This is important for several reasons. The unit does not have to be taken off-line to be cleaned. Any decision to install a redundant unit(s) will be less costly in this post digester process and is dependent on the final customer contract details associated with the surety of supply of organic-bio-solids, element(s) 303, 322, 367, 361, and bio-stimulants element 379, bio-solid.

In addition, Vincent Corporation offers several different i.t. rated fabric membranes. The objective is only to remove the larger volatile organic suspended solids element 310, and to do so with as little entrained water as possible to maximize the percent solids (consistency) of the sludge extracted, element 310. It is important to target for a 4 to 10% solids waste stream prior to collection in organic bio-sludge tank element 316. The tank is filled above the solids level with nitrogen gas to ensure maximum nitrogen nutrient content which in turn ensures maximum by-product value as does lower transportation costs due to higher solids concentrations.

Field tests utilizing the second stage of post digester filtration; the Vincent fabric filter by non-limiting example, element 307 can process waste streams, element 304 ranging from 1.1% to 6% solids and generate a sludge, element 310 with percent solids of up to 6 to 10%. Different fabric filter i.t. rated screens were used successfully during these field tests.

The filtrate element 313 must be directed into a transfer tank element 325. This is an enclosed tank intended to hold the filtered waste water. As much of the finer organic suspended solids material with its entrained nitrogen component is still in this stream, efforts must be made to minimize the volatilizing (off gassing) of nitrogen from this filtrate stream. Again, a nitrogen gas blanket is applied over the material accumulated in the covered tank, element 325. Element 334 and 337, the third stage of inline filtration after the digestion process is comprised by non-limiting example of disc type filters with air assist back wash function to minimize the dilution of the extracted suspended solids, element 343. Transfer pump element 243 controlled by tank level control element 242 pressurizes the filtrate, element 331 into the disc type filter(s) element 334 and 337 and will also provide enough residual line pressure within flow stream element 340 such that the supply conditions for the fourth stage post digester filtration process, element 346 and 349 FIG. 14 are also met.

Lab test results have confirmed that while utilizing multiple different i.t. rated disk filter openings in elements 334, 337, these units were able to achieve reduction of the residual volatile organic suspended solids down to levels near or below 1000 mg/L (1000 parts per million) in the filtrate, element 340 discharge stream.

In addition, it should be stated that the TSS removed from the waste stream post digester has already been subjected to the anaerobic digestion process and volatile organic content has been reduced as a result of this anaerobic digestion process.

Stage 2, 3 and 4 post digester filtration steps are installed with parallel operating units, elements 307 and 305, 334 and 337, 346 and 349 FIG. 14 to provide required process throughput capacity and operational equipment backup in event of failure and to permit regular periodic offline maintenance of these filtration pieces of equipment. The methods of self-cleaning for these filtration steps have been described above in this patent application. In addition, by non-limiting example the 3rd stage filter, element 334 and 337 must be installed with multiple units in parallel operation to permit taking some/or one of the units out of operation in order that they can be back washed for cleaning.

Based upon the specific characteristics of the waste stream being treated, anywhere from 60 to 90% of the organic suspended solids have been removed by the time that the filtrate, element 313 has been processed by 2nd stage and 3rd stage filter elements 307, 305, 334, 337 and is discharged as filtrate element 340 FIG. 14.

Unlike the 1st stage post digester filtration as defined by element 298 FIG. 14, where the concentrated organic waste material is constantly being removed from the waste stream by the self-cleaning and surface scouring action of the dewatering screw press, and the second stage post digester filtration, elements 307, 305 utilizes vibration of the filtration media surface to avoid surface pugging, the suspended organic solids in the 3rd stage filter, elements 334 and 337 FIG. 14 are accumulating on the disk filter surfaces. As mentioned previously at a certain predefined differential pressure across this membrane, a backwash function is initiated. In order to minimize the dilution of the removed organic waste accumulated on the membrane surface, compressed air rather than backwash water is the primary cleaning media. In this way the periodic removal of accumulated filtered organic suspended solids is removed at the highest percent solids possible.

This is critical in order to sustain and maintain the highest percent solids conditions of the waste sludge, element 343 FIG. 14 which in turn maintains the highest concentration of entrained bio-fertilizer components including but not limited to nitrogen and residual phosphorous. This valuable Class A bio-liquid/sludge with fine suspended solids content that accumulates in an enclosed nitrogen blanketed tank, element 344 has soil improving properties of a soil amender including but not limited to ground porosity, soil aggregation, water holding capacity of the soil as well as a source of micro-nutrients including but not limited to B Boron, Cl chlorine, Cu copper, Fe iron, Zn zinc, and Ni nickel as well as beneficial microbiology associated with plant health.

The filtrate element 313 within tank, element 325, is pumped through the 3rd stage disc filters with enough residual pressure to feed the 4th stage post digester filtration step, element 346 and 349 which utilizes ultrafilter membrane technology.

By nonlimiting example, element 346 is an ultrafiltration membrane assembly capable of filtering suspended solids down to 0.5 to 0.1 i.t. rating and are by nonlimiting example Flex disc II membranes manufactured by Avant. As in the case of the 1st, 2nd and 3rd stage post digestion filter stages, the fine particulate extracted from flow stream, element 340 removed by these membranes, element 346 and 349 FIG. 14 does not require a regularly scheduled incremental backwash water cycle which would otherwise decrease the concentration of nutrients extracted from the flow element 340 and simultaneously increase the volumes of element 355 FIG. 14 to be handled.

In the case of these membranes, FIG. 14 element 146, an air sparger is used to continually sweep the vertical surfaces of the suspended membranes within the tank filled with the discharge waste stream from the 3rd stage post digester filter, element 340 and remove the accumulated suspended solids. Based upon the light suspended solids content within flow stream element 340, the continual air sparger cleaning may only need to be periodically augmented with chemical cleaning which would require that some or one of the ultrafilter modules be taken offline at a time.

As referenced above, concentrated waste streams such as element 355 FIG. 14 with a minimized water component can be used as a bio liquid organic bio-stimulant that based on retention time and processing temperature within the upstream thermophilic anaerobic digester can be ORMI certified as a Class A bio-liquid/bio-stimulant with nutrient crop benefits including soil improving properties of a soil amender including but not limited to ground porosity, soil aggregation, water holding capacity of the soil as well as a source of micro-nutrients including but not limited to B Boron, Cl chlorine, Cu copper, Fe iron, Zn zinc, and Ni nickel as well as beneficial microbiology associated with plant health.

It should be stated that all bio sludge streams and bio-stimulant filtrate flows after the anaerobic digester step can all be ORMI certified as a Class A bio-liquid or bio=solid.

Element 355 would typically be directed to an enclosed nitrogen blanketed tank element 358 to be mixed with the bio-solids from tank(s), element 316 and/or low concentration liquids from the enclosed nitrogen blanketed tank(s), element 344 and 373 elements where they are mixed to match growers' specific recipes or applied as bio-stimulant with lower N, P, K, values but still possessing micro-nutrient and soil mechanics and biological attributes.

The filtrate, element 352 from the 4th stage filtration, element 346 and 359, by this point in the process has had between 90 to 99% by weight of the TSS removed.

Virtually all the phosphorous exiting the digester process, element 289 FIG. 14 has been removed by this point in the process. Approximately 30% of the original nitrogen in digester discharge flow stream, element 289 remains. Only the dissolved potassium which is unaffected by mechanical filtration steps detailed above will have more than 60% of the original amount exiting the digester remaining.

Much technical data has been published about the need for potassium. Potassium remains unbound to solids and facilitates enzyme activities necessary for crop growth. It is judged not to be a major source of Nutrient Land Management Act violations and does not pose a problem unlike phosphorous. Application of the filtrate stream, element 379 as irrigation water and/or used as an organic tea bio-stimulant can benefit crops, greenhouses, and almost all fruit and vegetable operations. In addition, other bio sludge materials, element(s) 303, 322, 367, 361 can be blended with filtrate stream element 379 to formulate specific and valuable irrigation/fertilizer blends with different N, P, K, ratios, different physical properties, different bio-solid properties and different soil mechanics benefits.

There are other opportunities associated with this extracted and concentrated sludge material that also have a high profitability.

As has been stated previously and confirmed by independent testing there is a high correlation between the particle size of extracted organics suspended solids and the removal of phosphorus; a key fertilizer constituent. Although nitrogen has different pathways by which it can be extracted from the original waste stream, there is a strong and discernible correlation between sludge removal and the removal of nitrogen, also a key fertilizer constituent. Potassium based upon its propensity to remain in the liquid form, and not be associated with the solid extraction streams, will have its highest concentration in the remaining liquid waste stream.

The details of how element(s) 303 and/or 322 by one embodiment can be added back as a further source of N P K in to the final filtrate stream element 379 to enhance or adjust the final P, N, K formulation, or the converse where element 379 can be added back into extracted sludge stream element(s) 303 and 322 has been discussed above in one nonlimiting case further detailed in the parallel blending strategies within pre-digester filtrate and sludge stream blending.

This approach in one embodiment would also apply to sludge streams, elements 367 and 361 in mixing with filtrate stream element 379 or the same converse approach as detailed above. There are multiple embodiments of this blending approach to formulate many bio-sludges and/or bio-fertilizer recipes not detailed within this patent application.

In one embodiment, there are multiple standard horizontal process centrifugal pumps, element 243 detailed in FIG. 14. Generally, these process pumps will have corrosion resistant wetted parts with variable speed drives to transfer or pressurize process flow streams.

In one embodiment there are multiple standard level transmitters, element 242 detailed in FIG. 14. These level transmitters provide output signals based on the level of the process material within the tank upon which they are mounted to provide logic control permissives for pumps to start/stop, as well as real time contents levels for process inventory.

In one embodiment there are multiple standard resettable totalizing flow transmitters, element 223 detailed in FIG. 14. These units can measure the specific volume of material transferred out of a tank and through the totalizing device to facilitate blending of different primary nutrients NPK, for a customized fertilizer blend(s).

In one embodiment, element 203 on FIG. 14 is a submersible pump capable of transferring the barn flush water complete with suspended solids and inorganic sand and lignin from the reception pit on a CAFO dairy to vibrating screen.

In one embodiment element 206 on FIG. 14 is a vibrating screen with interchangeable screens with different size perforations as well as amplitude and frequency adjustment of the oscillators to enhance rigid lignin removal.

In one embodiment element 209 on FIG. 14 is a Vincent screw press capable of dewatering lignin material to 30% solids by weight.

In one embodiment element 221 on 21 FIG. 14 is an in-line plastic process tank with conical or sloped bottom and an internal adjustable weir in order to adjust the flow stream velocity at the constricted process flow location of a sedimentation sand removal system to enhance inorganic sand like material removal.

In one embodiment, element 222 on FIG. 14 is an auger type solid handling pump used to remove inorganic sand like material from the collection area at the bottom of a sedimentation sand removal system.

In one embodiment element 227 on FIG. 14 is an in-line finely woven synthetic mesh fabric filter available in multiple micron opening sizes ranging from 100 i.t. down to 10 id. It is used to extract large particle organic suspended solids as well as the semi-gelatinous partially digested lignin material. The filtering surfaces are kept clean of accumulated extracted organic material by being continually vibrated and therefore do not use any backwash waters. Parallel units such as element 230 are installed for throughput capacity and/or redundancy.

In one embodiment element 233 on FIG. 14 is a positive displacement pump fabricated from suitable materials capable of pumping and shearing high solids content material extracted from fabric filter element 227 and transferring it to a Tea blend tank element 257 for subsequent mixing with other more dilute extracted sludge streams from the overall barn flush waste stream.

In one embodiment element 240 on FIG. 14 is a molded poly tank operating as a collection and transfer tank from which the contents are pumped onto the second filtration stage in the process. The tank is equipped with a typical level transmitter described elsewhere and is equipped with a low-pressure lid and nitrogen gas blanketing to minimize nitrogen losses from the contents. The discharge pump installed can also recirculate in the tank to re-homogenize contents.

In one embodiment element 249 on FIG. 14 is a disk filter assembly available in micron filtration ranges from 100 i.t. down to 5 id. The units use compressed air rather than backwash water to remove accumulated extracted organic suspended solids that have been removed from the waste stream. Element 252 on FIG. 14 is a disc filter assembly operating in parallel with element 249 to provide incremental throughput capacity and/or operational redundancy.

In one embodiment element 261 on FIG. 14 is an ultrafilter assembly operating with a very small differential pressure across the membrane surfaces. The membranes are suspended in a large tank with water flow through the surface of the membranes to a core water removal piping system. The units can operate with less than 5 inches of water pressure across the membranes. The units constantly remove the accumulated extracted suspended organic solids on the outer membrane surfaces by way of a rising air bubble curtain flowing over the filtration surfaces. The units are capable of filtering down to 0.5 i.t. suspended solids sized material. Element 264 on FIG. 14 is an ultrafilter assembly operating in parallel with element 261 to pro vide incremental throughput capacity and/or operational redundancy.

In one embodiment element 257 on FIG. 14 is a Tea Blend Tank which receives organic sludges from the various sequential filtration steps installed on the waste water process line. It is stainless steel tank to blend different organic extracted sludges with their specific NPK primary nutrient contents to a specific final formulation as defined by the needs of the end-user. In addition, this tank is fitted with a live steam injector to raise the solution temperatures to pasteurizing levels to achieve pathogen kill and Omri/Class A Biosolid status. The discharge pump installed can also recirculate in the tank to re-homogenize contents.

In one embodiment element 276 on FIG. 14 is an optional fourth stage wastewater filtration step. This reverse osmosis system filters dissolved solids and can be used to remove/control salt and/or other contaminants to further clean the waste stream and permit additional water recycle options. This will be a two-stage and perhaps an incremental third stage installed on the R 0 reject water stream.

The process equipment shown but not identified by element number(s) in FIG. 14 refers to the anaerobic thermophilic digester process and equipment which are detailed in a separate patent.

In one embodiment element 292 on FIG. 14 is the digester collection tank which sequentially receives the digestate on a programmed frequency from the modular digesters. It is equipped with a level transmitter element 242 and a discharge pump element 243. It receives a relatively high discharge flow rate from the digesters and discharges out at a slower continuous flow rate to flow element 298 on FIG. 14.

In one embodiment element 298 on FIG. 14 is a Vincent type screw press with a conical perforated compression section designed to dewater the organic suspended solids discharged from the digester(s).

In one embodiment element 301 on FIG. 14 is a typical plastic shipping tote or equivalent capable of holding the dewatered organic suspended solids with a nitrogen rich gas above the organic suspended solids to mitigate nitrogen off-gassing and reduce the nitrogen component of the primary nutrients NPK within the sludge.

In one embodiment element 307 on FIG. 14 is an in-line finely woven synthetic mesh fabric filter available in multiple micron opening sizes ranging from 100 i.t. down to 5 id. It is used to extract large particle organic suspended solids as well as the semi-gelatinous partially digested lignin material. The filtering surfaces are kept clean of accumulated extracted organic material by being continually vibrated and therefore do not use any backwash water. Parallel units like element 305 are installed for throughput capacity and/or redundancy.

In one embodiment element 316 on FIG. 14 is a molded poly collection tank with level transmitter element 242 and discharge and recirculation/re-homogenizing pump element 243. It is equipped with nitrogen blanketing to mitigate nitrogen loss and reduce the nitrogen component of the primary nutrients NPK within the sludge.

In one embodiment element 325 on FIG. 14 is a molded poly collection tank with level transmitter element 242 and discharge pump element 243 to transfer filtrate from the waste stream and pressurize and feed it into the next downstream filtration step element 334.

In one embodiment element 344 on FIG. 14 is a molded poly collection tank with level transmitter element 242 and discharge pump element 243 to collect fine organic sludge from the waste stream and distribute into other storage tanks for mixing of nutrient NPK ingredients to achieve a specific NPK formulation or directly discharge and into a tanker vehicle for delivery to customer. The tank is equipped with nitrogen blanketing to mitigate nitrogen loss and reduce the nitrogen component of the primary nutrients NPK as well as recirculating discharge piping to remix tank contents.

In one embodiment element 334 on FIG. 14 is a disk filter assembly available in micron filtration ranges from 100 i.t. down to 5 id. The units use compressed air rather than backwash water to remove accumulated extracted organic suspended solids that have been removed from the waste stream. Element 337 on FIG. 14 is a disc filter assembly operating in parallel with element 334 to provide incremental throughput capacity and/or operational redundancy.

In one embodiment element 346 FIG. 14 is the optional fourth stage. This is a reverse osmosis system capable of extracting dissolved organic material from the waste stream. It will typically be a two-stage RO in order to improve the overall recovery of the system. The reject stream from the reverse osmosis system may also have a small RO skid installed on it in order to separate the good dissolved nutrients from those that are not.

In one embodiment element 358 FIG. 14 is a molded poly collection tank with level transmitter element 242 and discharge pump element 243 to collect dissolved organic nutrients from the waste stream and distribute into other storage tanks or accept various sludge streams from the other sludge collection tanks for mixing of nutrient NPK ingredients to achieve a specific NPK formulation or directly discharge and into a tanker vehicle for delivery to customer. The tank is equipped with nitrogen blanketing to mitigate nitrogen loss and reduce the nitrogen component of the primary nutrients NPK as well as recirculating discharge piping to remix tank contents.

In one embodiment element 373 FIG. 14 is a molded poly collection tank with level transmitter element 242 and discharge pump element 243 to collect final reverse osmosis filtered water and distribute into other storage tanks or accept various sludge streams from the other sludge collection tanks for mixing of nutrient NPK ingredients to achieve a specific NPK formulation or directly discharge and into a tanker vehicle for delivery to customer. The tank is equipped with nitrogen blanketing to mitigate nitrogen loss and reduce the nitrogen component of the primary nutrients NPK as well as recirculating discharge piping to remix tank contents.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed:

1. A method for processing an aqueous primarily organic waste stream with filtration stages;
a first waste stream reception pit in one embodiment coupled to the flush discharge flow to transform large surge flows into smaller continuous flows;
a vibrating screen coupled to the first waste stream reception pit using discharge from
first set of centrifugal pumps and producing a vibrating screen coarse organic waste discharge;
a screw press coupled to the vibrating screen coarse organic waste discharge;
an adjustable weir within an inorganic sedimentation settling tank coupled to the vibrating screen coarse waste discharge gravity chute to remove inorganic solids, with settled inorganic solids at a bottom of the inorganic sedimentation settling tank coupled to an inorganic accumulation pile;
a mechanical vibration apparatus an air powered backwash and air bubble filtration surface scouring i applied sequentially to a pre digester filtration stage and maximize a sludge suspended solids content by weight at each filtration stage, with sludges from each filtration stage transferred to at least one of: an anaerobic digester blend tank, a tea blend tank, a direct discharge;
a blanket nitrogen gas being piped to the filtration stages;
an in-line process stage coupled to a final filtrate to remove dissolved solids.

2. A method for processing an aqueous primarily organic digestate from an anaerobic digester with filtration stages that produce a progressively finer filter media comprising:
an in-line process stage and coupled to a final filtrate to remove dissolved solids;
a mechanical vibration apparatus with an air powered backwash and an air bubble filtration surface scouring applied sequentially to the filtration stages configured to maximize sludge suspended solids content by weight at each of a filtration stage and then, wherein sludges from each of a filtration stage are transferred to at least one of: transfer tanks; organic bio-sludge tank; fine organic solids; a nutrient blend tank through an on-line volumetric measuring device, wherein blanket nitrogen gas is piped to each of a post digester tanks.

3. The system of claim 1, further comprising:
elevating the vibrating screen.

4. The system of claim 1, wherein the vibrating screen has noncorrosive wetted parts.

5. The system of claim 4, wherein: the vibrating screen is configured to accept interchangeable screens with different size perforations.

6. The system of claim 4, wherein: the vibrating screen is configured to have an adjustable amplitude and frequency.

7. The system of claim 4, wherein: the vibrating screen continually extracts all targeted suspended organic material.

8. The system of claim 1, further comprising: a corrosion resistant screw press to dewater extracted vibrating screen coarse particulate solids to level of up to 32% solids.

9. The system of claim 1, further comprising: a sedimentation settling tank with at least one of: a conical bottom; and a sloped bottom.

10. The system of claim 9, wherein: the sedimentation settling tank extracts sand like material.

11. The system of claim 9, wherein: the sedimentation settling tank is selected from at least one of: an auger; and a positive displacement pump.

12. The system of claim 9, wherein: the sedimentation settling is operated on a timed cycle.

13. The system of claim 11, wherein: the sedimentation settling tank produces accumulated sludge/sand inorganics transferred by gravity to a pile accessible by a front end loader.

14. The system of claim 1, further comprising: a pre-digester first stage filter with selectable micron rated membranes ranging from 100 micron to 20 microns to achieve a high volatile organic sludge solids level ranging from 5 to 12%.

15. The system of claim 14, wherein: the first stage filter is mechanically vibrated continually to avoid sludge accumulation.

16. The system of claim 1, further comprising: a pre-digester second stage filter utilizing non-metallic disc filters of selectable micron ratings to achieve high volatile organic sludge solids levels ranging up to 1 to 7%.

17. The system of claim 16, wherein: the disc filters range from 100 micron to 5 micron to remove organic sludge of greater than 5 micron from a waste stream.

18. The system of claim 16, wherein: the disc filters use a continually measured differential pressure across the disc filters to detect units with surface plugging and trigger a backwash of the units to remove surface sludge accumulation.

19. The system of claim 18, wherein: the disc filters utilize compressed air as a motive force for disc backwash surface cleaning.

20. The system of claim 1, further comprising: a third stage filter with filter opening sizes of 0.2 to 0.3 micron levels to remove the targeted suspended volatile organic material of greater than 0.5 micron.
